(19) United States
(12) Patent Application Publication
(10) Pub. No.: US 2026/0368115 A1
(43) Pub. Date: Nov. 19, 2026

(54) Address Translation Across Address Domains in Multi-Chiplet Systems

(71) Applicant: Tenstorrent USA, Inc., Austin, TX (US)

(72) Inventors: Zhimin Chen, San Jose, CA (US); Roy Franz, Roseville, CA (US); Lichen Weng, San Jose, CA (US)

(21) Appl. No.: 19/680,352

(22) Filed: May 18, 2026

Related U.S. Application Data
(60) Provisional application No. 63/807,880, filed on May 18, 2025.

(51) Int. Cl. G06F 13/28

(52) U.S. Cl. CPC G06F 13/28; G06F 2213/40

(57) ABSTRACT

Systems and methods related to address translations for multi-chiplet systems are disclosed herein. A source chiplet of a multi-chiplet system may include a local address map defining an address region that routes to local resources and an address region allocated to one of its inter-chiplet ports. The source chiplet may also include routing logic configured to receive an outgoing communication carrying an address expressed in the local address map and direct the communication to the inter-chiplet port based on the address. The source chiplet may also include a configuration interface configured to convey a base address of the address region allocated to the inter-chiplet port to a configuration agent in a target address domain of the target chiplet. At the inter-chiplet port, the address carried by the outgoing communication may be expressed in the local address map of the source chiplet.

### CROSS REFERENCE TO RELATED APPLICATIONS

This application claims the benefit of U.S. Provisional Patent Application No. 63/807,880, filed May 18, 2025, which is incorporated by reference herein in its entirety for all purposes.

### BACKGROUND

The present description relates to address translations at target domains in a network of chiplets. Chiplets are small, specialized integrated circuits designed to function as individual components in a larger system of which they form a part. Chiplets are then integrated together to form a system, such as a System in Package (SiP), which behaves like a traditional monolithic silicon chip, especially from high-level software perspective. Unlike traditional monolithic integrated circuits where all functions are manufactured together on a single piece of silicon, chiplets may be designed, fabricated, and assembled separately. This approach allows for greater flexibility, improved yields, higher cost efficiency, and shorter time to market. While a chiplet-based SiP offers appealing advantages, it also brings new challenges to the SiP development, especially interoperability among various chiplets. There is a growing demand to standardize the chiplet interfaces and assure interoperability so that the advantages are indeed redeemed.

Among the challenges that arise in chiplet-based systems, the handling of memory addresses across chiplet boundaries is particularly difficult. Individual chiplets are often designed independently, by different teams or different vendors, and at different times. Each chiplet typically defines its own internal address map — the assignment of address values to memory locations, registers, and other resources within that chiplet — without coordination with the chiplets it may ultimately be packaged alongside. As a result, when chiplets are assembled into a SiP, their address maps are unlikely to align. The same numerical address value may correspond to one resource in one chiplet's address map and to an entirely different resource in another chiplet's address map. Overlap between address maps is not the exception but rather the expected condition.

This independence of address maps creates difficulties when a communication originating in one chiplet must reach a resource located in another chiplet. The originating chiplet emits an address that has meaning only within its own address map, but the destination resource is identified by a different address — one that has meaning within the destination chiplet's address map. Some mechanism must reconcile these two address spaces so that the communication arrives at the intended resource and not at some unintended location that happens to share the same numerical address value.

The complexity grows further when a communication must traverse one or more additional chiplets between its origin and its destination. Such intermediate chiplets may themselves have their own address maps, distinct from those of both the originating and destination chiplets. If each chiplet along the path must interpret the communication's address within its own address map, the system as a whole must somehow coordinate address assignments across all participating chiplets, or each chiplet must be made aware of the address conventions used by every other chiplet it might communicate with. Either approach imposes substantial design and integration burdens, undermines the modularity that motivates the chiplet approach in the first place, and limits the extent to which chiplets from different vendors can be combined.

Additional complications arise from the variety of translation mechanisms that may be employed and from the security implications of where translation is performed. Chiplets may rely on different translation techniques, ranging from fixed remapping of address ranges to dynamic, page-table-based translation, and may host translation logic locally or depend on translation logic located elsewhere in the system. Determining where, in a system spanning multiple independently-designed chiplets, the authoritative translation between address spaces is performed has implications not only for correctness but also for which chiplet bears responsibility for enforcing access policies on memory and other resources, making the placement of translation responsibility a recurring source of complication in chiplet-based system design.

Existing approaches to address translation address only portions of the difficulties described above. Approaches developed for monolithic integrated circuits typically presuppose a single coherent address space shared across the system, a single point of translation between device-side and host-side address spaces, or design-time coordination of address assignments. Board-level interconnect standards such as PCI Express do permit devices coupled to the same interconnect to operate under independent address spaces, but the mechanisms by which such standards reconcile those address spaces are defined within the context of a single interconnect protocol and presuppose a host-centric topology in which translation responsibility is concentrated at the host. None of these approaches provides an architectural framework that operates across independently-designed chiplets, with independently-defined address maps, that are assembled into packages whose composition may not be known to any individual chiplet vendor in advance, and in which the route from source to destination may traverse one or more intermediate chiplets each defining its own address domain. There is a need for such an architectural framework.

### SUMMARY

The present disclosure provides an architectural framework for handling addresses across the boundaries of independently-designed chiplets in a multi-chiplet system. The framework addresses the difficulties associated with chiplet systems by establishing a clear and consistent rule for where address translation occurs, by separating the routing of communications from the translation of the addresses those communications carry, and by defining a standardized interface through which source-side address allocation is communicated to target-side translation logic.

In accordance with the disclosed framework, each chiplet in a multi-chiplet system may be associated with one or more address domains. An address domain is a scope within which a set of addresses is used to access memory or other resources, and within which each address value has a single, well-defined meaning. The address maps of different address domains are independent — the same numerical address value in different domains may refer to entirely different resources. A chiplet may contain a local address domain confined to itself, and an address domain may span multiple chiplets where appropriate. Address domains may be defined in a manner that does not require coordination across independently-designed chiplets: each chiplet may define its address map independently, and overlaps between address values in different domains are accordingly permitted and expected.

When a communication originates in a source chiplet and is directed to a resource located in a different address domain (the target address domain), the communication may carry an address expressed in the source chiplet's address map. Translation into the target address map may be performed at the entry point of the target address domain. In some embodiments, no translation of the address is performed at any chiplet outside that domain along the path of the communication (i.e., an intermediate chiplet along the path may refrain from translating the address carried by the communication and may instead forward the communication based on its own local address map or based on routing information separate from the address (such as a target identifier, a source identifier, or other metadata carried with the communication)). In other embodiments, however, an intermediate chiplet along the path may itself be associated with an intermediate address domain and may perform translation of the address at an entry point of the intermediate address domain in accordance with the same architectural rule (i.e., that translation occurs at the entry point of an address domain). In such embodiments, the address carried by the communication may be translated more than once along the route, with each translation occurring at the entry point of a respective address domain crossed by the communication, and with the address as carried by the communication being expressed in the address map of whichever address domain the communication is currently within. The entry point of the target address domain is the logical boundary at which a communication transitions from being interpreted under one address map to being interpreted under another. In some embodiments, this entry point is physically located within the target chiplet — for example, at or downstream of an ingress inter-chiplet port through which the target chiplet receives communications from one or more source chiplets. In other embodiments, the target address domain extends into a source chiplet, and the entry point is physically located within the source chiplet — for example, at an address translation cache that is part of the target address domain but resides inside the source chiplet. The disclosed framework accommodates both placements through a common architectural rule defined in terms of address domains rather than chiplet boundaries, allowing a variety of translation mechanisms and placements to be supported within the same architecture.

In some embodiments, because translation occurs only at the entry point of the target address domain, communications may traverse any portion of their path or route outside that domain carrying addresses expressed in the source chiplet's address map. That is, before the communication enters the target address domain, the address of the communication may be unchanged from the source address. Intermediate chiplets along the path, if any, may forward communications toward the target chiplet without modifying the addresses they carry. Each intermediate chiplet may make its forwarding decision by reference to its own local address map, identifying an outbound inter-chiplet port allocated to handle communications whose addresses fall within particular regions of that map. Intermediate chiplets may not be required to interpret addresses within any other chiplet's address map, and intermediate chiplets may not be required to coordinate with any other chiplet regarding the meaning of the addresses it forwards. This property allows the framework to operate correctly across arbitrary chiplet topologies, including topologies in which communications traverse multiple intermediate chiplets between origin and destination. In other embodiments, an intermediate chiplet is associated with an intermediate address domain through which the communication passes and is configured to translate the address carried by the communication at an entry point of that intermediate address domain, to forward the communication based on the translated address expressed in the intermediate chiplet's local address map, and, upon the communication exiting the intermediate chiplet, to leave the address as translated or to subject it to a further translation at the entry point of a downstream address domain. The disclosed framework accommodates each of these embodiments as instances of the same architectural rule that translation, where required, is performed at the entry point of an address domain.

To allow translation at the target address domain to be configured without requiring runtime discovery or design-time coordination of address maps, a source chiplet may declare, to a configuration agent operating within the target address domain, the address regions of its local address map that are allocated to each of its outgoing inter-chiplet ports. In some embodiments, each such inter-chiplet port may have a bounded number of contiguous address regions allocated to it, and the source chiplet may convey at least the base address of each such region (and in some embodiments also the size or end address of each such region) to the target's configuration agent during a boot process of the multi-chiplet system. The target's translation logic may be configured based on the received allocation information, so that addresses arriving at the entry point of the target address domain from each source can be correctly translated into the target address map.

Where communications from multiple source chiplets converge on the same target address domain, the system may include per-source translation. The target's translation logic may maintain a plurality of translation contexts, each corresponding to a particular source from which communications may originate, and may select among these contexts based on a source identifier associated with each received communication. The source identifier may be conveyed by metadata carried with the communication, by the identity of the ingress inter-chiplet port on which the communication is received, by a security identifier carried with the communication, or by a combination of these. This per-source context selection allows two communications carrying identical source address values but originating from different source chiplets to be translated correctly into different addresses in the target address map, in accordance with the independently-defined address maps of their respective source chiplets.

Responsibility for configuring the translation logic may reside with a configuration agent operating in association with the target address domain. For example, in specific embodiments, the configuration agent may operate within the target address domain. In other embodiments, the configuration agent may be a system management controller in a different chiplet (which may be in a different address domain) that acts on the target chiplet’s behalf. Source chiplets may declare their address region allocations through the standardized interface but may not configure (and are not required to have any knowledge of the operation of) the translation logic itself. This placement of configuration responsibility within the target address domain decouples the proprietary translation mechanisms employed by any particular target chiplet from the standardized interface used for source-side allocation, supports security architectures in which translation control is isolated within the target's trust boundary, and allows the target's translation implementation to evolve independently of any source chiplet.

Features of the disclosed frameworks (e.g., translation at the entry point of the target address domain, addresses unchanged in transit, in some embodiments, intermediate chiplets operating only on their own local address maps when forwarding communications between address domains other than their own, and in other embodiments, intermediate chiplets performing translation at the entry point of their own address domains, standardized boot-time declaration of source-side region allocations, per-source translation context selection at the target, and configuration responsibility located within the target address domain) may provide architectures for chiplet-based systems in which chiplets defined independently by different designers and vendors can be assembled into systems that operate correctly regardless of topology, and without requiring global coordination of address maps.

In specific embodiments of the invention, a source chiplet for use in a multi-chiplet system is provided. The source chiplet comprises: an inter-chiplet port for communicating with a target chiplet in the multi-chiplet system; a local address map defining an address region that routes to local resources of the source chiplet and an address region allocated to the inter-chiplet port; routing logic configured to receive an outgoing communication carrying an address expressed in the local address map, and direct the communication to the inter-chiplet port based on the address falling within the address region allocated to the inter-chiplet port, without modifying the address expressed in the local address map; and a configuration interface configured to convey a base address of the address region allocated to the inter-chiplet port to a configuration agent in a target address domain of the target chiplet. At the inter-chiplet port, the address carried by the outgoing communication is expressed in the local address map of the source chiplet.

In some embodiments, the configuration interface between source and target chiplets is implemented over a low-bandwidth, highly-available sideband channel that is physically and/or logically distinct from the primary inter-chiplet communication path that carries communications carrying addresses. Such a sideband channel may be implemented over a low-pin-count two-wire bus, including without limitation an Inter-Integrated Circuit (I2C) bus, an Improved Inter-Integrated Circuit (I3C) bus, or other management bus. In other embodiments, the configuration information is conveyed over the same physical inter-chiplet communication path used to convey the addressed communications, distinguished from data traffic by protocol-level identifiers, dedicated logical channels, or timing within a boot process of the multi-chiplet system

In specific embodiments of the invention, a target chiplet for use in a multi-chiplet system is provided. The target chiplet comprises: one or more ingress inter-chiplet ports for receiving communications originating from one or more source chiplets in the multi-chiplet system, each communication carrying a source address expressed in a local address map of the source chiplet from which the communication originated; a target address domain associated with the target chiplet, the target address domain having a target address map independent of the local address map of any source chiplet; an address translator positioned at an entry point of the target address domain, the address translator configured to translate the source address of each received communication into a translated address expressed in the target address map; and a plurality of translation contexts, each translation context corresponding to a source from which communications originate. Each translation context comprises information sufficient to translate addresses expressed in that source's local address map into addresses expressed in the target address map. The target chiplet also comprises context selection logic configured to select, for each received communication, one of the translation contexts of the plurality of translation contexts based at least in part on a source identifier associated with the received communication; and a configuration interface configured to receive address region allocation information for each source chiplet whose communications the target chiplet is configured to receive. The address translator and the translation contexts are configured based on the address region allocation information received through the configuration interface.

In specific embodiments of the invention, a network of chiplets is provided. The network of chiplets comprises a first chiplet defining a first address domain having a first address map and a second chiplet defining a second address domain having a second address map independent of the first address map. The first address map and the second address map permit overlapping address values that refer to different resources in their respective address domains. The network of chiplets also comprises an inter-chiplet communication path coupling the first chiplet to the second chiplet and an address translator positioned at an entry point of the second address domain, the address translator configured to translate addresses from the first address map into the second address map. The first chiplet is configured to emit a communication directed to a resource in the second address domain, the communication carrying an address. For any portion of a route that the communication traverses outside the second address domain, the communication carries the address expressed in the first address map. For any portion of the route that the communication traverses within the second address domain, the communication carries the address as translated by the address translator into the second address map.

In specific embodiments of the invention, a source chiplet for use in a multi-chiplet system is provided. The source chiplet comprises: a local address domain associated with the source chiplet, the local address domain having a local address map defined independently of address maps of other chiplets in the multi-chiplet system; an inter-chiplet port for communicating with a target chiplet in the multi-chiplet system, the target chiplet being associated with a target address domain having a target address map independent of the local address map, the local address map and the target address map permitting overlapping address values that refer to different resources in their respective domains; an address translator located within the source chiplet, the address translator being part of the target address domain such that the target address domain extends into the source chiplet at the address translator, the address translator configured to translate addresses from the local address map into the target address map; routing logic configured to: (i) receive an outgoing communication carrying an address expressed in the local address map and directed to a resource in the target address domain, (ii) cause the address to be translated by the address translator into a translated address expressed in the target address map, and (iii) direct the communication to the inter-chiplet port based on the translated address; and a configuration interface configured to receive, from a configuration agent operating within the target address domain, translation information enabling the address translator to translate addresses from the local address map into the target address map. The address carried by the outgoing communication, upon traversing the inter-chiplet port, is expressed in the target address map.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a layered model of a chiplet architecture in accordance with specific embodiments of the inventions disclosed herein.

FIG. 2 illustrates an example of a chiplet network with a base chiplet in accordance with specific embodiments of the inventions disclosed herein.

FIG. 3 illustrates an example of a chiplet network showing address domains and address translation between them in accordance with specific embodiments of the inventions disclosed herein.

FIG. 4 illustrates an example of a chiplet network in which the boundary of target address domain aligns with the boundary of the target chiplet in accordance with specific embodiments of the inventions disclosed herein.

FIG. 5 illustrates an example of a chiplet arrangement in which an entry point of a target address domain is located within a source chiplet in accordance with specific embodiments of the inventions disclosed herein.

FIG. 6 illustrates an example of a chiplet arrangement in which a communication originating at a source chiplet traverses an intermediate chiplet before reaching a target chiplet and in which address translation occurs at the target chiplet in accordance with specific embodiments of the inventions disclosed herein.

FIG. 7 illustrates an example of a chiplet arrangement in which a communication originating at a source chiplet traverses an intermediate chiplet before reaching a target chiplet and in which address translation occurs within the source chiplet in accordance with specific embodiments of the inventions disclosed herein.

FIG. 8 illustrates an example of a chiplet arrangement in which a communication originating at a source chiplet traverses multiple intermediate chiplets along an inter-chiplet communication path before reaching a target chiplet in accordance with specific embodiments of the inventions disclosed herein.

FIG. 9 illustrates an example of a chiplet arrangement in which a source chiplet directs outgoing communications to different inter-chiplet ports based on the addresses carried by the communications in accordance with specific embodiments of the inventions disclosed herein.

FIG. 10 illustrates an example of a chiplet arrangement in which a target chiplet receives communications from multiple source chiplets through a shared ingress inter-chiplet port in accordance with specific embodiments of the inventions disclosed herein.

FIG. 11 illustrates an example of a self-sufficient address translation and an example of a non-self-sufficient address translation in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for address translations at target domains in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

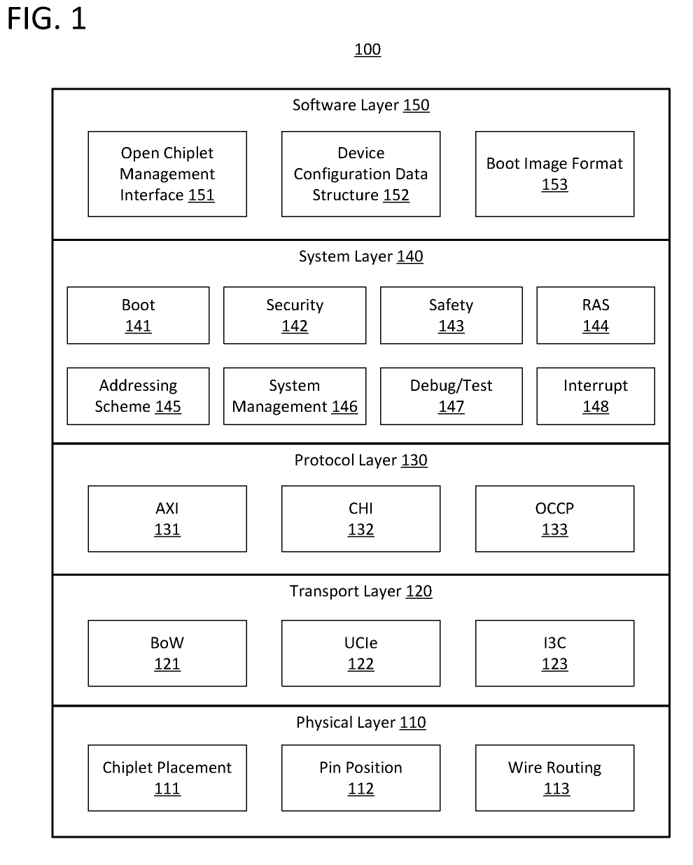

FIG. 1 illustrates layered model 100 of a chiplet architecture in which the framework disclosed herein may operate. Layered model 100 includes physical layer 110, transport layer 120, protocol layer 130, system layer 140, and software layer 150. Physical layer 110 (including chiplet placement 111, pin position 112, and wire routing 113) defines the physical structures across which inter-chiplet communications carrying addresses are conveyed between chiplets. Transport layer 120 (including transport mechanisms such as Bunch of Wires (BoW) 121, Universal Chiplet Interconnect Express (UCIe) 122, and Improved Inter-Integrated Circuit (I3C) 123) provides means by which communications carrying addresses are transported between chiplets; in some embodiments, address-region allocation information disclosed herein is conveyed between source and target chiplets over a low-bandwidth sideband transport such as I3C 123, separate from a primary inter-chiplet path used to convey the addressed communications themselves. Protocol layer 130 (including inter-chiplet communication protocols such as Advanced eXtensible Interface (AXI) 131, Coherent Hub Interface (CHI) 132, and Open Chiplet Communication Protocol (OCCP) 133) defines how addresses, source identifiers, and related metadata are encoded, framed, and interpreted within inter-chiplet communications, with a given inter-chiplet link in a multi-chiplet system using AXI 131, CHI 132, OCCP 133, or another inter-chiplet communication protocol.

System layer 140 includes addressing functionality and other system-level functions of a chiplet architecture, including boot 141, security 142, safety 143, reliability / availability / serviceability (RAS) 144, addressing scheme 145, system management 146, debug/test 147, and interrupt 148. The addressing framework disclosed herein corresponds to addressing scheme 145 and, in various embodiments, interacts with one or more of the other system-layer functions: source-side address-region allocation information may be conveyed to target-side configuration agents during boot 141; translation at an entry point of a target address domain may serve as a point at which access-control and isolation policies of security 142 are enforced; deterministic and recoverable address-handling behavior at a translation entry point may support safety 143 and RAS 144; configuration of translation logic and observation of address-translation behavior may be performed through system management 146 and debug/test 147; and communications under interrupt 148 may themselves carry addresses subject to the disclosed framework. Software layer 150 (including Open Chiplet Management Interface (OCMI) 151, device configuration data structure 152, and boot image format 153) provides software-visible mechanisms that may interact with the addressing framework: OCMI 151 may carry management and configuration messages (including, in some embodiments, address-region allocation information) between chiplets; device configuration data structure 152 may describe address maps, address regions, translation parameters, and other address-related properties of chiplets in the multi-chiplet system; and boot image format 153 may carry static address-region allocation information, translation-context configuration, or other address-related data used by configuration agents of one or more target address domains during a boot process. The framework described herein (in which translation between address maps occurs at the entry point of an address domain, source-side address-region allocations are conveyed to configuration agents operating within target address domains, and configuration of translation logic resides within the target address domain) may be implemented at one or more of these layers in any combination, and is not limited to any particular layered partitioning of a chiplet architecture or to any particular transport or protocol within a given layer.

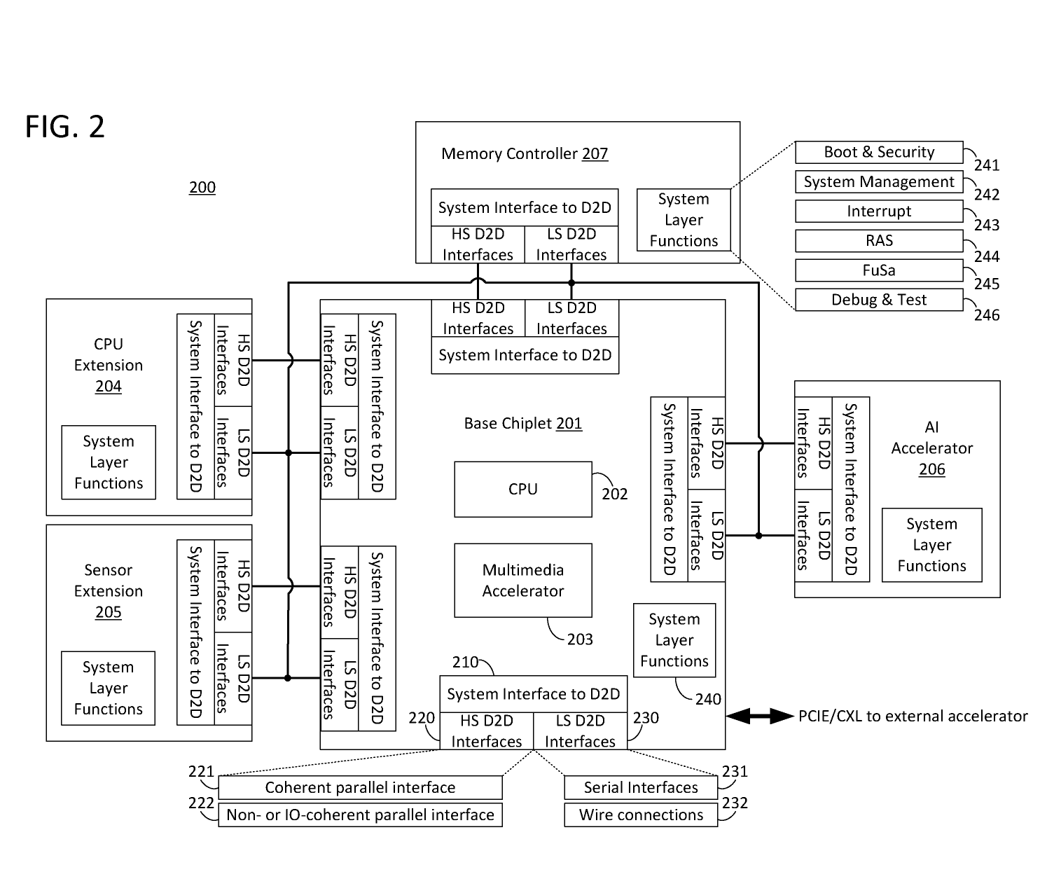

FIG. 2 illustrates an example of chiplet network 200 with base chiplet 201 in accordance with specific embodiments of the inventions disclosed herein. The arrangement of chiplets shown in FIG. 2 is illustrative of an extended chiplet integration in which a base chiplet is coupled to one or more extension chiplets that provide additional compute, memory, sensing, or acceleration functionality. In the illustrated embodiment, chiplet network 200 includes base chiplet 201 having CPU 202 and multimedia accelerator 203. Base chiplet 201 is coupled to additional chiplets, such as CPU extension 204, sensor extension 205, AI accelerator 206, and memory controller 207. In the illustrated example, base chiplet 201 is also shown as being connectable to an external accelerator through a PCIe/CXL connection. In some embodiments, each of base chiplet 201, CPU extension 204, sensor extension 205, AI accelerator 206, and memory controller 207 is associated with one or more address domains, and the address maps of those address domains may be defined independently for each chiplet. Address values used by one chiplet may overlap with address values used by another chiplet while referring to different resources in their respective domains.

One or more chiplets may include a System Interface to die-to-die (D2D) 210 and corresponding high-speed (HS) D2D Interfaces 220 and low-speed (LS) D2D Interfaces 230. In the illustrated example, the System Interface to D2D 210 may serve as an interface between local functional circuitry of a chiplet and die-to-die communication resources used to communicate with other chiplets. The HS D2D Interfaces 220 may correspond to higher-bandwidth chiplet-to-chiplet communication resources, while the LS D2D Interfaces 230 may correspond to lower-bandwidth, control-oriented, or out-of-band communication resources. By way of example, the HS D2D Interfaces 220 may be associated with a coherent parallel interface 221 or a non-coherent or IO-coherent parallel interface 222, while the LS D2D Interfaces 230 may be associated with serial interfaces 231 or wire connections 232. In some embodiments, HS D2D Interfaces 220 and LS D2D Interfaces 230 of a given chiplet correspond to inter-chiplet ports through which the chiplet may emit or receive communications carrying addresses. A chiplet's local address map may allocate one or more contiguous address regions to each such inter-chiplet port, such that communications carrying addresses falling within an allocated region are routed to the corresponding port. In some embodiments, the number of contiguous address regions allocated to any single inter-chiplet port may be bounded by a predetermined maximum.

In some embodiments, inter-chiplet communications across the multi-chiplet system carry addresses of a width sufficient to accommodate the full address range of any source address domain whose addresses traverse the system. The address width carried on inter-chiplet communication paths may be specified by an inter-chiplet address width parameter associated with the multi-chiplet system. In some embodiments, the inter-chiplet address width parameter is selected such that all bits of an address carried by a communication are available to address translation logic at the entry point of a target address domain, without truncation, padding, or other modification of the address as carried across the inter-chiplet communication path. The inter-chiplet address width parameter may be set at design time of the multi-chiplet system, may be common to all inter-chiplet communication paths in the multi-chiplet system, or may vary between inter-chiplet communication paths in different portions of the multi-chiplet system.

In specific embodiments, System Interface to D2D 210 may include or cooperate with a protocol bridge and attribute extension. The protocol bridge and attribute extension may support functions such as address translation and remap, secure communication, functional safety (FuSa) communication, and RAS communication. In this manner, the System Interface to D2D 210 can provide adaptation between local chiplet functions and one or more selected die-to-die communication mechanisms, while also carrying channel-related attributes or domain-specific information used for inter-chiplet communication. In some embodiments, the address translation function associated with System Interface to D2D 210 is positioned at an entry point of an address domain associated with the chiplet in which System Interface to D2D 210 resides, such that addresses arriving at the chiplet from other address domains are translated upon entry into the chiplet's address domain. In other embodiments, System Interface to D2D 210 may include or cooperate with an address translation cache that is part of an address domain associated with a different chiplet, in which case addresses are translated within the chiplet hosting System Interface to D2D 210 prior to being emitted through HS D2D Interfaces 220 or LS D2D Interfaces 230. In some embodiments, the attribute extension associated with System Interface to D2D 210 carries source-identifying information alongside addresses, such that a chiplet receiving a communication may determine the source address domain from which the communication originated and select a corresponding translation context.

In the illustrated embodiment, one or more chiplets further include system layer functions 240. Example system layer functions may include Boot and Security 241, System Management 242, Interrupt 243, RAS 244, FuSa 245, and Debug and Test 246. The system-level functionality of a chiplet may be architecturally distinct from the lower-layer communication resources used to carry inter-chiplet traffic. In some embodiments, system layer functions 240 of a chiplet further include functions associated with addressing and address translation, including the configuration of address translation logic at the entry point of an address domain associated with the chiplet and the declaration, to a configuration agent of another chiplet's address domain, of the address regions of the chiplet's local address map allocated to each of its inter-chiplet ports.

In some embodiments of the present disclosure, one or more of the functions shown in FIG. 2 may be implemented as respective architectural channels at a system layer. For example, a Boot channel, Security channel, System Management channel, Interrupt channel, RAS-related channel, FuSa channel, Address Translation channel, or Debug/Test channel may be defined as a system-layer communication construct that is maintained independently of any one particular bus protocol, transport mechanism, or physical interface. The System Interface to D2D of a chiplet may then map traffic of a selected architectural channel to an available and compatible lower-layer implementation, such as an HS D2D interface or an LS D2D interface, depending on operating state, interface availability, or compatibility between communicating chiplets. In this manner, the identity of the architectural channel may be preserved while the physical realization used to carry that channel changes. In some embodiments, an Address Translation channel may carry address translation requests, address translation responses, and page request messages between a translation agent located in one chiplet and a translation requester located in another chiplet, allowing translation logic to be located flexibly within the chiplet network.

Although FIG. 2 illustrates an extended integration using a base chiplet 201, the disclosed subject matter is not limited to that organization. In other embodiments, a chiplet network may use a centralized chiplet or hub chiplet that primarily provides interconnection among chiplets, rather than serving as a base chiplet to which extension chiplets are attached. In still other embodiments, a chiplet network may use a distributed topology without a hub, in which chiplets communicate through peer-to-peer or otherwise distributed interconnections and each participating chiplet includes corresponding system-interface-to-D2D functionality and system-layer functions. Thus, the particular physical organization of chiplets may vary while still using system-layer architectural channels and lower-layer channel mappings as described herein. In some embodiments, the placement of address translation at the entry point of a target address domain, and the transmission of addresses unchanged across portions of a path outside the target address domain, are maintained regardless of whether the chiplet network uses an extended topology with a base chiplet, a centralized topology with a hub chiplet, or a distributed topology without a hub.

Accordingly, FIG. 2 should be understood as one non-limiting example of a chiplet network in which chiplet functions are partitioned across multiple chiplets, system-layer functions are maintained separately from lower-layer D2D communication resources, and architectural channels may be mapped onto different physical communication resources within the chiplet network. The number, type, and placement of chiplets, as well as the particular organization of the System Interface to D2D, HS D2D Interfaces, LS D2D Interfaces, protocol bridges, and system layer functions, may vary in different embodiments.

In hierarchical system architectures, where chiplets can assume different roles, some chiplets may act as primaries while other chiplets may act as secondaries. A primary chiplet serves as the main control element for a specific functional domain. For each functional domain, there may be a single primary chiplet in a package, while other chiplets operate as secondaries. Different functional domains may have different requirements for the primary chiplet. For example, a boot primary chiplet may have the requirement of booting first, having access to necessary peripheral interfaces, and booting up the rest of the SiP. In specific embodiments, a single chiplet may serve as the primary chiplet across all function domains. In specific embodiments, a SiP integrator may choose to designate different chiplets as the primary for distinct function domains. A chiplet intended to serve as the central controller of the SiP may be designed to support the primary functions of all relevant domains. Chiplets may be designed with secondary capabilities and interfaces to support multi-instantiation and to provide the SiP integrator with the flexibility to designate the appropriate primary for each function domain. In some embodiments, a primary chiplet for a given functional domain may host a configuration agent that receives address region allocation information from one or more other chiplets and configures address translation logic accordingly. In some such embodiments, the base chiplet 201 of FIG. 2 acts as a primary chiplet across multiple functional domains and includes such a configuration agent.

In specific embodiments, chiplets in a package and their inter-chiplet couplings may be organized into a topology in which a given chiplet may be a root, a leaf, or a non-leaf. A leaf is an end chiplet with no further downstream chiplet. A non-leaf may act as an intermediate chiplet along a path traveled by a communication originating at one chiplet and directed to another. In some embodiments, an intermediate chiplet forwards a communication toward its destination without modifying the address carried by the communication, identifying the outbound inter-chiplet port through which to forward the communication based on the address falling within an address region of the intermediate chiplet's local address map allocated to that outbound inter-chiplet port. In other embodiments, an intermediate chiplet performs translation of the address carried by the communication at an entry point of an intermediate address domain associated with the intermediate chiplet, in accordance with the disclosed rule that translation occurs at the entry point of an address domain. The number, type, and arrangement of chiplets, the topology of inter-chiplet couplings, and the placement and form of address domains across the topology may vary in different embodiments.

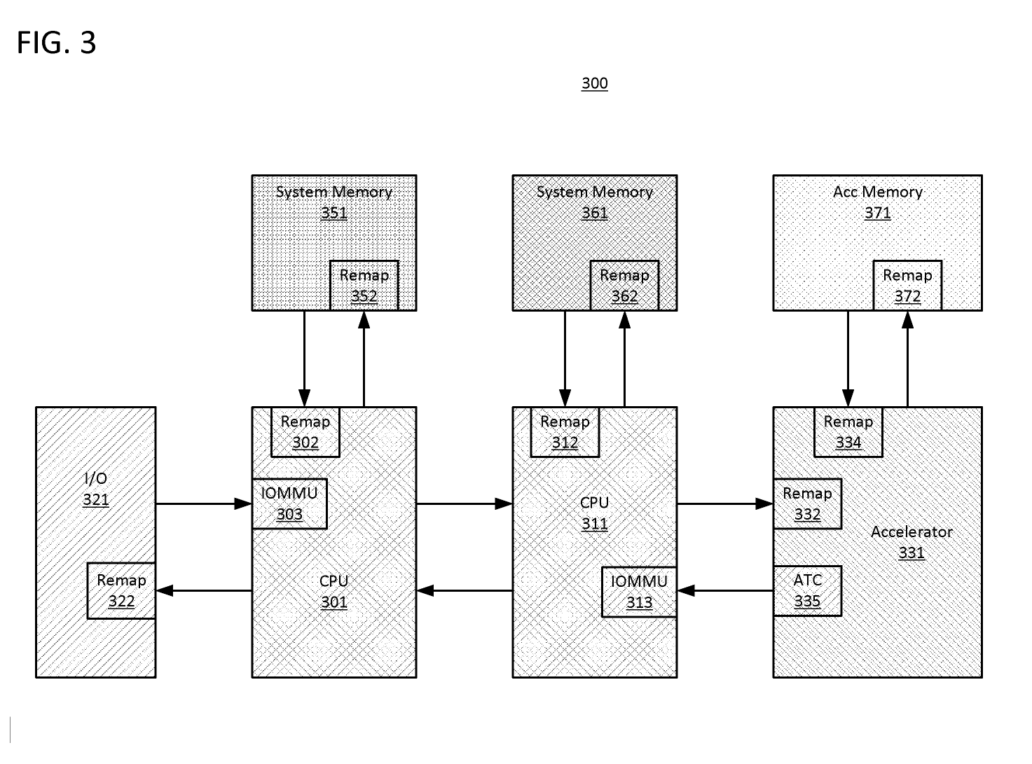

FIG. 3 illustrates an example of chiplet network 300 showing address domains and address translation between them in accordance with specific embodiments of the inventions disclosed herein. The arrangement of chiplets shown in FIG. 3 is illustrative of a chiplet network in which multiple chiplets, each associated with one or more address domains, exchange communications carrying addresses across inter-chiplet communication paths. In the illustrated embodiment, chiplet network 300 includes CPU 301, CPU 311, I/O chiplet 321, accelerator chiplet 331, system memory 351, system memory 361, and accelerator memory 371.

In the illustrated embodiment, CPU 301 and CPU 311 are coupled to one another and together participate in a shared address domain. CPU 301 includes remap unit 302 and input/output memory management unit (IOMMU) 303. CPU 311 includes remap unit 312 and IOMMU 313. I/O chiplet 321 is coupled to CPU 301 and includes remap unit 322. Accelerator chiplet 331 is coupled to CPU 311 and includes address translation cache (ATC) 335, remap unit 332, and remap unit 334. System memory 351 is coupled to CPU 301 and includes remap unit 352. System memory 361 is coupled to CPU 311 and includes remap unit 362. Accelerator memory 371 is coupled to accelerator chiplet 331 and includes remap unit 372. The particular arrangement of chiplets, couplings, and translation elements shown in FIG. 3 is illustrative; in other embodiments, more or fewer chiplets, different couplings, or different placements of translation elements may be used.

In some embodiments, each of CPU 301, CPU 311, I/O chiplet 321, accelerator chiplet 331, system memory 351, system memory 361, and accelerator memory 371 is associated with one or more address domains. An address domain is a scope within which a set of addresses is used to access memory or other resources, and within which each address value has a well-defined meaning. In FIG. 3, different address domains are illustrated using different shading. The address maps of different address domains may be defined independently, such that the same numerical address value used in different address domains may refer to entirely different resources. In the illustrated embodiment, CPU 301 and CPU 311 together participate in a shared address domain spanning both chiplets, using a unified address map across them, such that communications between CPU 301 and CPU 311 within the shared address domain do not undergo address translation. By contrast, I/O chiplet 321, accelerator chiplet 331, system memory 351, system memory 361, and accelerator memory 371 are each associated with their own respective address domains, distinct from the shared address domain of CPU 301 and CPU 311.

In specific embodiments, communications crossing from one address domain to another undergo translation at the entry point of the destination address domain. As shown in FIG. 3, IOMMU 303 of CPU 301 and IOMMU 313 of CPU 311 are positioned at entry points of the shared CPU address domain. IOMMU 303 is configured to translate addresses arriving from I/O chiplet 321, which originate in the address domain of I/O chiplet 321, into addresses expressed in the CPU shared address domain. IOMMU 313 is configured to translate addresses arriving from accelerator chiplet 331, which originate in address domain of accelerator chiplet 331, into addresses expressed in the CPU shared address domain. In each case, the translation is performed upon entry into the CPU shared address domain, and the addresses carried by the communications before reaching IOMMU 303 or IOMMU 313 remain expressed in the originating chiplet's address map.

In some embodiments, IOMMU 303 and IOMMU 313 each comprise dynamic address translators configured to perform page-table-based translation. A page table walker associated with each IOMMU may retrieve translation entries from memory, and a translation cache associated with each IOMMU may store recently-used translations to reduce the latency of subsequent translations of the same addresses. In other embodiments, IOMMU 303 and IOMMU 313 may comprise other forms of address translation logic suitable for translating addresses into the CPU shared address domain.

In some embodiments, remap unit 302, remap unit 312, remap unit 322, remap unit 332, remap unit 334, remap unit 352, remap unit 362, and remap unit 372 each comprise static remap units configured to translate addresses based on fixed mappings between source address ranges and target address ranges. A static remap unit may translate an incoming address into an outgoing address by adding an offset to the incoming address, by selecting an output range based on the incoming address falling within a specified input range, or by other fixed transformations. In some embodiments, the mappings used by a static remap unit may be configured during a boot process of chiplet network 300 and remain fixed during operation.

In some embodiments, remap unit 302 and remap unit 312 are positioned at entry points of the CPU shared address domain for communications arriving from system memory 351 and system memory 361, respectively. Remap unit 302 may translate addresses originating in the address domain of system memory 351 into addresses expressed in the CPU shared address domain. Remap unit 312 may translate addresses originating in the address domain of system memory 361 into addresses expressed in the CPU shared address domain. Remap unit 332 is positioned at an entry point of the address domain of accelerator chiplet 331 for communications arriving from outside accelerator chiplet 331. These communications may come from CPU 311 although they may originate from CPU 301, system memory 351, etc. Remap unit 334 is positioned at an entry point of the address domain of accelerator chiplet 331 for communications arriving from accelerator memory 371. Remap unit 322 within I/O chiplet 321 is positioned at an entry point of the address domain of I/O chiplet 321 for communications arriving from CPU 301. Communications may originate in other chiplets in network 300 and may be transferred through CPU 301, and similar indirect routes may be used to communicate with other chiplets. Remap unit 352 within system memory 351 is positioned at an entry point of the address domain of system memory 351 for communications arriving from CPU 301. Remap unit 362 within system memory 361 is positioned at an entry point of the address domain of system memory 361 for communications arriving from CPU 311. Remap unit 372 within accelerator memory 371 is positioned at an entry point of the address domain of accelerator memory 371 for communications arriving from accelerator chiplet 331.

In some embodiments, ATC 335 of accelerator chiplet 331 is an address translation cache that is part of the CPU shared address domain even though ATC 335 is physically located within accelerator chiplet 331. That is, the CPU shared address domain extends into accelerator chiplet 331 chiplet at ATC 335. ATC 335 is configured to translate addresses from the address domain of accelerator chiplet 331 into addresses expressed in the CPU shared address domain. When a communication originating within accelerator chiplet 331 is directed to a resource in the CPU shared address domain, the communication's address may be translated by ATC 335 within accelerator chiplet 331, prior to the communication being emitted from accelerator chiplet 331 toward CPU 311. In such cases, the address carried by the communication, upon traversing the inter-chiplet path between accelerator chiplet 331 and CPU 311, is expressed in the CPU shared address domain rather than in the address domain of accelerator chiplet 331.

In some embodiments, ATC 335 is configured to translate addresses for which it has valid translation entries. When ATC 335 lacks a valid translation entry for a particular address, ATC 335 may forward a translation request to a translation agent located in CPU 311, such as IOMMU 313, via the inter-chiplet path between accelerator chiplet 331 and CPU 311. ATC 335 may receive a translation response from the translation agent and use the received translation entry to translate the address. In such embodiments, the inter-chiplet path between accelerator chiplet 331 and CPU 311 carries both translated data traffic and translation requests and responses between ATC 335 and IOMMU 313. In other embodiments, ATC 335 may be self-sufficient and may complete translations without requiring assistance from translation logic located outside accelerator chiplet 331.

In some embodiments, configuration of the address translation elements in chiplet network 300 is performed by configuration agents operating within the respective destination address domains. For example, a configuration agent operating within the CPU shared address domain may configure IOMMU 303, IOMMU 313, remap unit 302, remap unit 312, and ATC 335 — each of which translates addresses into the CPU shared address domain. A configuration agent operating within the address domain of accelerator chiplet 331 may configure remap unit 332 and remap unit 334. A configuration agent operating within the address domain of I/O chiplet 321 may configure remap unit 322. Configuration agents operating within the respective memory chiplets' address domains may configure remap unit 352, remap unit 362, and remap unit 372. In some embodiments, this configuration is performed during a boot process of chiplet network 300, using address region allocation information conveyed by source chiplets to the configuration agents of the relevant destination address domains.

In specific embodiments, an address carried by a communication traversing chiplet network 300 may undergo communication-changing translation only once over the course of its path between an originating chiplet and a final destination even if the path crosses multiple address domains. Within the intermediate address domains, chiplets may read and translate the original address of the communication without changing the communication. For example, a communication originating within I/O chiplet 321 and directed to a resource in system memory 351 may, upon entering the CPU shared address domain at IOMMU 303, have its address translated by IOMMU 303 from the address map of I/O chiplet 321 into the CPU shared address map; the communication may then be routed through CPU 301 within the CPU shared address domain carrying the translated address, and may have its address translated again by remap unit 352 upon entering the address domain of system memory 351 at an entry point of that domain. In such an embodiment, the address carried by the communication is translated once at each entry into a successive address domain along its route, in accordance with the architectural rule that translation occurs at the entry point of an address domain. In other embodiments, an intermediate chiplet along the route may forward a communication without modifying the address carried by the communication (e.g., where the intermediate chiplet treats the communication as a passthrough not entering the intermediate chiplet's address domain, or where the forwarding decision is made based on routing information separate from the address carried by the communication (such as a target identifier, a source identifier carried as metadata, or a security identifier carried with the communication)). The disclosed framework supports both modes of operation, and embodiments may combine them along different segments of the same route. Remap unit 352 may, upon the communication’s entry into the address domain of system memory 351, translate the address as it is carried by the communication since system memory 351 is the target address domain for the communication.

Alternatively, in specific embodiments, an address carried by a communication traversing a chiplet network may undergo translation more than once over the course of its path between an originating chiplet and a final destination, if the path crosses multiple address domains. For example, a communication originating within an I/O chiplet and directed to a resource in a system memory may have its address translated by an IOMMU upon entry into the CPU shared address domain, and may then have the translated address translated again by a remap unit upon entry into the address domain of the system memory. Each translation may be performed at the entry point of the address domain that the communication is entering, and the communication may carry the address expressed in the address map appropriate to whichever address domain it is currently within.

FIG. 3 should be understood as one non-limiting example of a chiplet network in which multiple chiplets, each associated with one or more address domains, exchange communications carrying addresses. The number, type, and arrangement of chiplets, the placement and type of address translation elements, the assignment of chiplets to shared or local address domains, and the topology of inter-chiplet couplings may vary in different embodiments. The disclosed framework — in which addresses are translated at the entry point of a destination address domain, with address translation logic configured by a configuration agent operating within that domain — is applicable to a wide range of such arrangements.

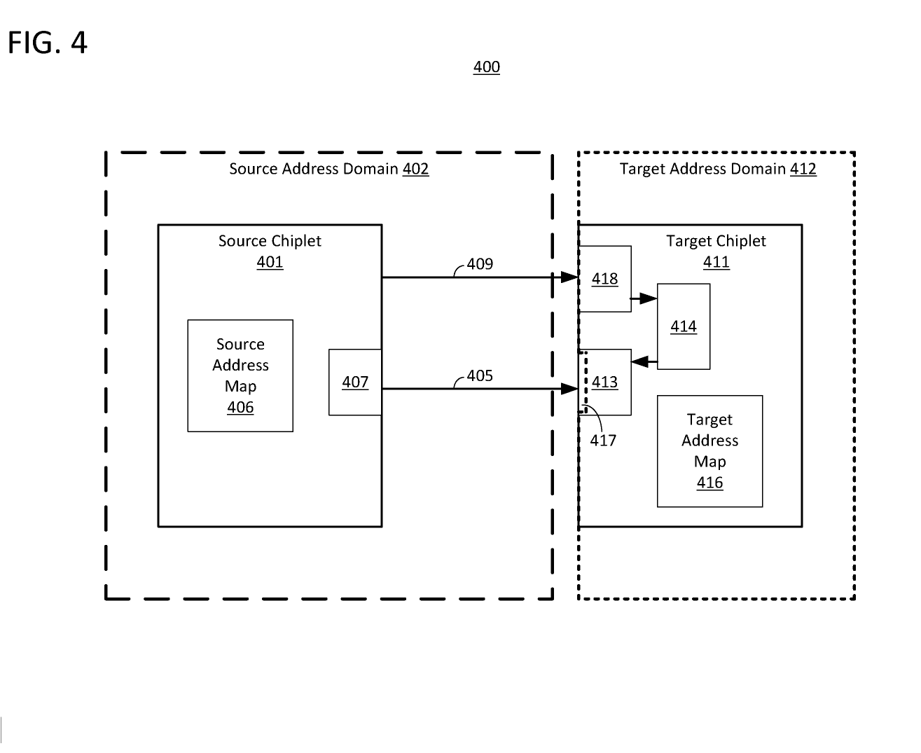

FIG. 4 illustrates an example of chiplet network 400 in which the boundary of target address domain 412 aligns with the boundary of target chiplet 411 in accordance with specific embodiments of the inventions disclosed herein. In the illustrated embodiment, chiplet network 400 includes source chiplet 401 and target chiplet 411 coupled to one another by an inter-chiplet communication path. Source chiplet 401 emits communication 405 carrying an address to target chiplet 411 along the inter-chiplet communication path. Address translation is performed at an entry point of target address domain 412 located within target chiplet 411. The arrangement of chiplets shown in FIG. 4 is illustrative; in other embodiments, more chiplets, additional coupling arrangements, or additional translation elements may be present.

In the illustrated embodiment, source chiplet 401 is associated with source address domain 402 and target chiplet 411 is associated with target address domain 412. Source address domain 402 operates under source address map 406, and target address domain 412 operates under target address map 416. Source address map 406 and target address map 416 may be defined independently of one another. In specific embodiments, source address map 406 and target address map 416 may be defined at design time of the respective chiplets without coordination between source chiplet 401 and target chiplet 411 regarding address value assignments, and remain independent after source chiplet 401 and target chiplet 411 are integrated into chiplet network 400. Source address map 406 and target address map 416 may permit overlapping address values that refer to different resources in their respective domains, such that a given numerical address value may correspond to one resource within source address domain 402 and to an entirely different resource within target address domain 412.

In the illustrated embodiment, target chiplet 411 includes translator 413 and configuration agent 414. Translator 413 is positioned at an entry point of target address domain 412. The entry point of target address domain 412 is located within target chiplet 411, as illustrated by the position of translator 413 at or adjacent to an ingress portion of target chiplet 411. In some embodiments, the entry point of target address domain 412 is located at or downstream of an ingress inter-chiplet port 417 of target chiplet 411 through which communications may be received from source chiplet 401 and other chiplets, if any.

In the illustrated embodiment, source chiplet 401 is configured to emit communication 405 directed to a resource in target address domain 412. Communication 405 carries an address. As communication 405 is emitted from source chiplet 401 and traverses the inter-chiplet communication path between source chiplet 401 and target chiplet 411, communication 405 carries the address expressed in the source address map. The address remains expressed in the source address map for any portion of the path that communication 405 traverses outside target address domain 412. Because the entry point of target address domain 412 is located within target chiplet 411, communication 405 carries the address expressed in the source address map across the entirety of the inter-chiplet communication path between source chiplet 401 and target chiplet 411 and until communication 405 reaches translator 413 within target chiplet 411.

In some embodiments, source chiplet 401 is configured to emit communication 405 toward target chiplet 411 without modifying the address expressed in the source address map, and without reference to the target address map. Source chiplet 401 may direct communication 405 to an inter-chiplet port of source chiplet 401 based on the address falling within an address region of the local address map of source chiplet 401 that is allocated to that inter-chiplet port. In some embodiments, source chiplet 401 has no awareness of address values used in target address domain 412, such that source chiplet 401 directs communication 405 to the inter-chiplet port irrespective of the target address map. The independence of source address domain 402 from target address domain 412, and the routing of communication 405 by source chiplet 401 based only on the local address map of source chiplet 401, may allow source chiplet 401 and target chiplet 411 to be designed independently without coordination regarding address value assignments.

In some embodiments, translator 413 is configured to translate the address carried by communication 405 from the source address map into a translated address expressed in the target address map. Translation by translator 413 may be performed upon communication 405 entering target address domain 412 at the entry point. For any portion of a route that communication 405 traverses within target address domain 412, communication 405 may carry the address as translated by translator 413 into the target address map. In some embodiments, translation of the address carried by communication 405 is performed exactly once along the route between source chiplet 401 and the resource in target address domain 412 to which communication 405 is directed, at the entry point of target address domain 412.

In some embodiments, translator 413 may comprise a dynamic address translator configured to perform page-table-based translation of addresses from the source address map into the target address map. In other embodiments, translator 413 may comprise a static remap unit configured to translate addresses from the source address map into the target address map based on fixed mappings between source address ranges and target address ranges. In still other embodiments, translator 413 may comprise a combination of dynamic and static translation logic. The particular implementation of translator 413 is not limited to any one of these forms.

In some embodiments, target chiplet 411 further includes configuration agent 414. Configuration agent 414 may be located within target address domain 412 and may be configured to configure translator 413. In some embodiments, configuration agent 414 may receive, through configuration interface 418 of target chiplet 411, address region allocation information 409 from source chiplet 401, the address region allocation information 409 specifying one or more address regions of the local address map of source chiplet 401 that are allocated to inter-chiplet port 407 of source chiplet 401 through which target chiplet 411 is reachable. Configuration agent 414 may use the received address region allocation information 409 to configure translator 413, such that addresses arriving at translator 413 from source chiplet 401 can be correctly translated from the source address map into the target address map. In some embodiments, configuration agent 414 performs this configuration during a boot process of chiplet network 400.

In some embodiments, configuration agent 414 maintains one or more translation contexts for translator 413, each translation context corresponding to a source from which communications may originate. When translator 413 receives a communication from a particular source, translator 413 may select the translation context corresponding to that source and use the selected context to translate the address carried by the communication. The configuration of translation contexts by configuration agent 414, based on address region allocation information 409 received from one or more source chiplets including source chiplet 401, may allow translator 413 to translate addresses received from each source chiplet according to the address map of that source chiplet, even when multiple source chiplets use overlapping address values in their respective address maps.

In some embodiments, address region allocation information 409 is conveyed dynamically from source chiplet 401 to configuration agent 414 of target chiplet 411 during a boot process of chiplet network 400. In other embodiments, address region allocation information 409 is statically determined at design time of the multi-chiplet system and is made available to configuration agent 414 from non-volatile storage of target chiplet 411 (such as firmware or other read-only configuration data embedded in target chiplet 411), from non-volatile storage of another chiplet that participates in the target address domain, or from a SiP-level firmware image accessible to target chiplet 411 during boot. In still other embodiments, address region allocation information 409 may be conveyed in part dynamically and in part statically, with portions of the allocation determined at design time and other portions determined at boot time. The disclosed framework accommodates each of these arrangements, and the configuration interface of target chiplet 411 may be configured to obtain address region allocation information 409 from any one or more of the above sources.

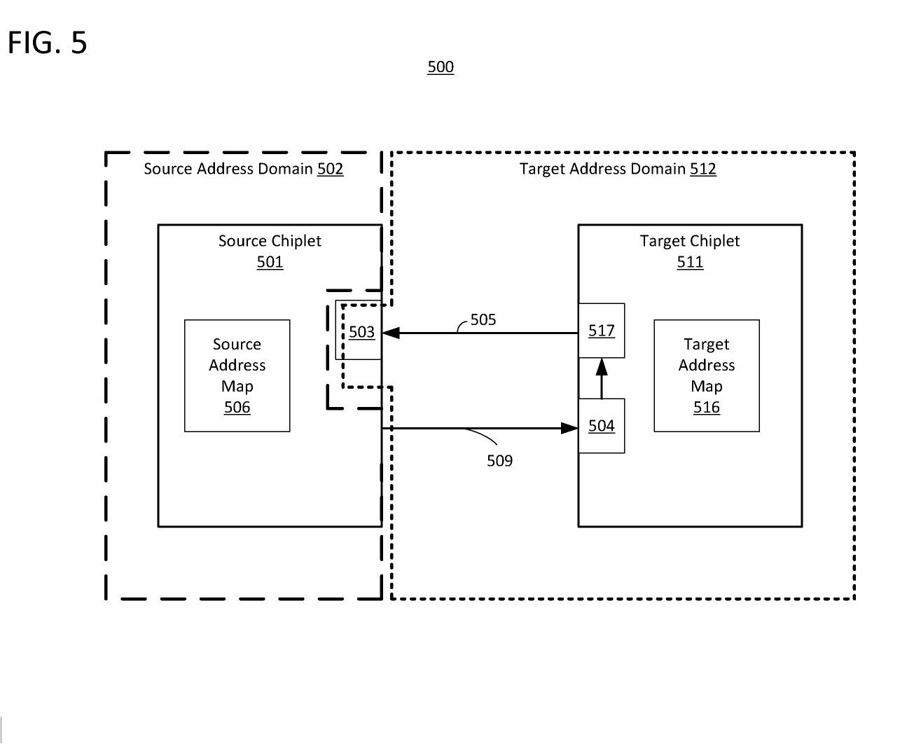

FIG. 5 illustrates an example of a chiplet arrangement in accordance with specific embodiments of the inventions disclosed herein, in which an entry point of a target address domain is located within a source chiplet such that the target address domain extends into the source chiplet. The chiplet network 500 shown in FIG. 5 differs from the arrangement shown in FIG. 4 in the location of the entry point of the target address domain and, correspondingly, the location of the translator at which addresses are translated from a source address map into a target address map. In the illustrated embodiment, the chiplet arrangement includes source chiplet 501 and target chiplet 511 coupled to one another by an inter-chiplet communication path.

In the illustrated embodiment, source chiplet 501 is associated with source address domain 502 and target chiplet 511 is associated with target address domain 512. As illustrated by the dashed boundaries depicting source address domain 502 and target address domain 512, target address domain 512 extends from target chiplet 511 into source chiplet 501. That is, a portion of source chiplet 501 lies within target address domain 512, while another portion of source chiplet 501 lies within source address domain 502. The entry point of target address domain 512 is located within source chiplet 501 at the boundary between the portion of source chiplet 501 that is within source address domain 502 and the portion of source chiplet 501 that is within target address domain 512.

In the illustrated embodiment, translator 503 is located within source chiplet 501 and is positioned at the entry point of target address domain 512. Although translator 503 is physically located within source chiplet 501, translator 503 is part of target address domain 512 rather than part of source address domain 502. Translator 503 is configured to translate addresses from the source address map 506 of source address domain 502 into the target address map 516 of target address domain 512.

In some embodiments, translator 503 is configured by a configuration agent 504 operating within target address domain 512. Translator 503 may be an address translation cache. Configuration agent 504 is located in target chiplet 511. Translator 503 may receive translation rules via communication 505 from translation agent 517 (e.g., an IOMMU or other translation logic of target address domain 512 that maintains the authoritative source-to-target translation entries). Translation agent 517 may be configured for this purpose by agent 504 which receives translation information 509 (e.g., base address information) from source chiplet 501. The translation rules may allow translator 503 to translate addresses from the source address map into the target address map. In embodiments where the configuration agent and the translator are on separate chiplets, the configuration agent may provide the translation information to the translator through a configuration interface.

In the illustrated embodiment, source chiplet 501 is configured to emit a communication directed to a resource in target address domain 512. As the communication originates within the portion of source chiplet 501 lying within source address domain 502, the communication initially carries an address expressed in the source address map. Upon reaching translator 503 at the entry point of target address domain 512, the communication has its address translated by translator 503 into a translated address expressed in the target address map. The communication then continues, carrying the translated address, through the inter-chiplet communication path to target chiplet 511. In some embodiments, translation of the address carried by the communication is performed exactly once along the route of the communication, at the entry point of target address domain 512 within source chiplet 501.

Because translator 503 is located within source chiplet 501 and performs translation before the communication is emitted from source chiplet 501, the address carried by the communication upon traversing the inter-chiplet communication path between source chiplet 501 and target chiplet 511 is expressed in the target address map rather than in the source address map. In some embodiments, the communication carries the address translated in the target domain through any inter-chiplet ports, inter-chiplet communication paths, and intermediate chiplets along its route. For example, the communication may enter the target domain through translator 503. In specific embodiments, the address expression of the communication may be governed by which address domain the communication is currently within, irrespective of which chiplet the communication is currently within.

In some embodiments, translator 503 may comprise an address translation cache configured to store translations from the source address map of source address domain 502 into the target address map of target address domain 512. The address translation cache may store a plurality of translation entries, each translation entry mapping an address in the source address map to a corresponding address in the target address map. When translator 503 receives an address for which a corresponding translation entry is stored, translator 503 may translate the address using the stored translation entry. When translator 503 receives an address for which no corresponding translation entry is stored, translator 503 may obtain a translation entry from a translation agent located outside source chiplet 501.

In some embodiments in which translator 503 comprises an address translation cache, translator 503 may be configured to, upon lacking a valid translation for an address required by a communication, forward a translation request to a translation agent located in target chiplet 511 via an inter-chiplet port of source chiplet 501. The translation agent located in target chiplet 511 may perform a translation lookup, retrieve a corresponding translation entry, and return the translation entry to translator 503 in a translation response. Translator 503 may then use the received translation entry to translate the address carried by the communication. In such embodiments, the inter-chiplet communication path between source chiplet 501 and target chiplet 511 carries both data traffic — including the communication with its translated address — and translation request and response traffic between translator 503 and the translation agent in target chiplet 511.

In other embodiments, translator 503 comprises an IOMMU configured to perform page-table-based translation of addresses from the source address map into the target address map. The IOMMU may include a page table walker configured to retrieve translation entries from memory accessible to the IOMMU. In such embodiments, the IOMMU is self-sufficient with respect to translation, meaning that the IOMMU is configured to perform translation lookups, walk page tables, and produce translated addresses without requiring assistance from translation logic located outside source chiplet 501. Communications crossing from source chiplet 501 to target chiplet 511 in such embodiments carry translated addresses expressed in the target address map, and the inter-chiplet communication path between source chiplet 501 and target chiplet 511 does not need to carry translation requests or responses between translator 503 and translation logic in target chiplet 511.

In still other embodiments, translator 503 comprises a static remap unit configured to translate addresses from the source address map into the target address map based on fixed mappings between source address ranges and target address ranges. The static remap unit may translate an address by applying a fixed offset, by selecting an output range based on the address falling within a specified input range, or by other fixed transformations. The fixed mappings used by the static remap unit may be configured by the configuration agent operating within target address domain 512 during a boot process of the chiplet arrangement, and may remain fixed during operation. In some such embodiments, the static remap unit is self-sufficient with respect to translation and does not require assistance from translation logic located outside source chiplet 501 during operation.

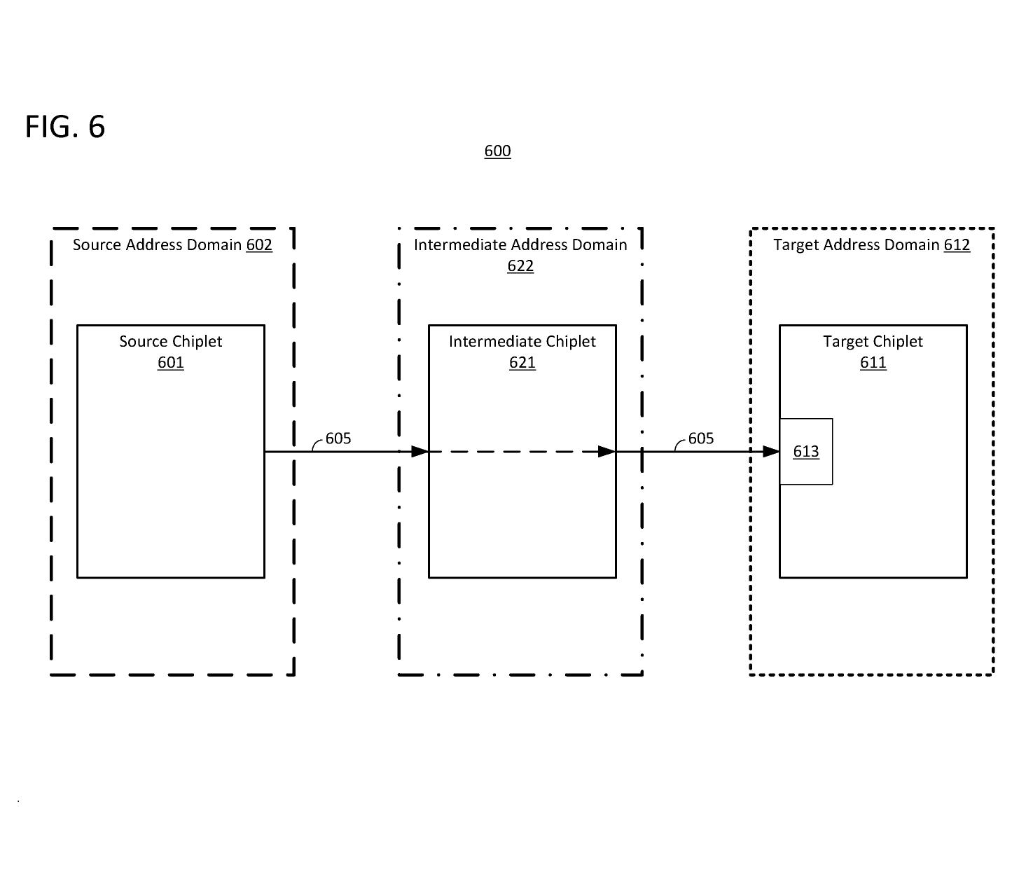

FIG. 6 illustrates an example of a chiplet arrangement in accordance with specific embodiments of the inventions disclosed herein, in which a communication originating at a source chiplet traverses an intermediate chiplet before reaching a target chiplet, and in which translation between the source address map and the target address map occurs at the target chiplet. Chiplet network 600 shown in FIG. 6 includes source chiplet 601, intermediate chiplet 621, and target chiplet 611. Source chiplet 601 is associated with source address domain 602, intermediate chiplet 621 is associated with intermediate address domain 622, and target chiplet 611 is associated with target address domain 612. Each of source address domain 602, intermediate address domain 622, and target address domain 612 may have its own respective address map, defined independently of the others.

In the illustrated embodiment, source chiplet 601 is configured to emit communication 605 directed to a resource in target address domain 612. Communication 605 carries an address expressed in the source address map of source address domain 602. Communication 605 traverses source chiplet 601 within source address domain 602, exits source chiplet 601 through an inter-chiplet port, and arrives at intermediate chiplet 621.

In some embodiments, intermediate chiplet 621 is configured to forward communication 605 toward target chiplet 611 without modifying the address carried by communication 605. Although intermediate chiplet 621 internally operates with respect to intermediate address domain 622 for its own internal traffic, communication 605 is not interpreted by intermediate chiplet 621 as a communication originating within intermediate address domain 622. Instead, intermediate chiplet 621 treats communication 605 as a communication to be forwarded toward its destination. Intermediate chiplet 621 may identify an outbound inter-chiplet port through which to forward communication 605 based on the address carried by communication 605 falling within an address region of the local address map of intermediate chiplet 621 that is allocated to that outbound inter-chiplet port, and may forward communication 605 through the identified outbound inter-chiplet port with the address unchanged from the address carried by communication 605 when received by intermediate chiplet 621.

As communication 605 traverses intermediate chiplet 621 and the inter-chiplet communication paths between source chiplet 601, intermediate chiplet 621, and target chiplet 611, the address carried by communication 605 remains expressed in the source address map of source address domain 602. The address is not translated upon entry into intermediate chiplet 621, is not translated within intermediate chiplet 621, and is not translated upon exit from intermediate chiplet 621. From the perspective of address translation, communication 605 remains within source address domain 602 throughout its traversal of intermediate chiplet 621, even though intermediate chiplet 621 itself is associated with intermediate address domain 622.

Communication 605 reaches target chiplet 611 and enters target address domain 612 at translator 613, which is positioned at an entry point of target address domain 612 within target chiplet 611. Translator 613 may be configured to translate the address carried by communication 605 from the source address map of source address domain 602 into a translated address expressed in the target address map of target address domain 612. In some embodiments, translation of the address carried by communication 605 is performed exactly once along the route between source chiplet 601 and the resource in target address domain 612 to which communication 605 is directed, at the entry point of target address domain 612 within target chiplet 611.

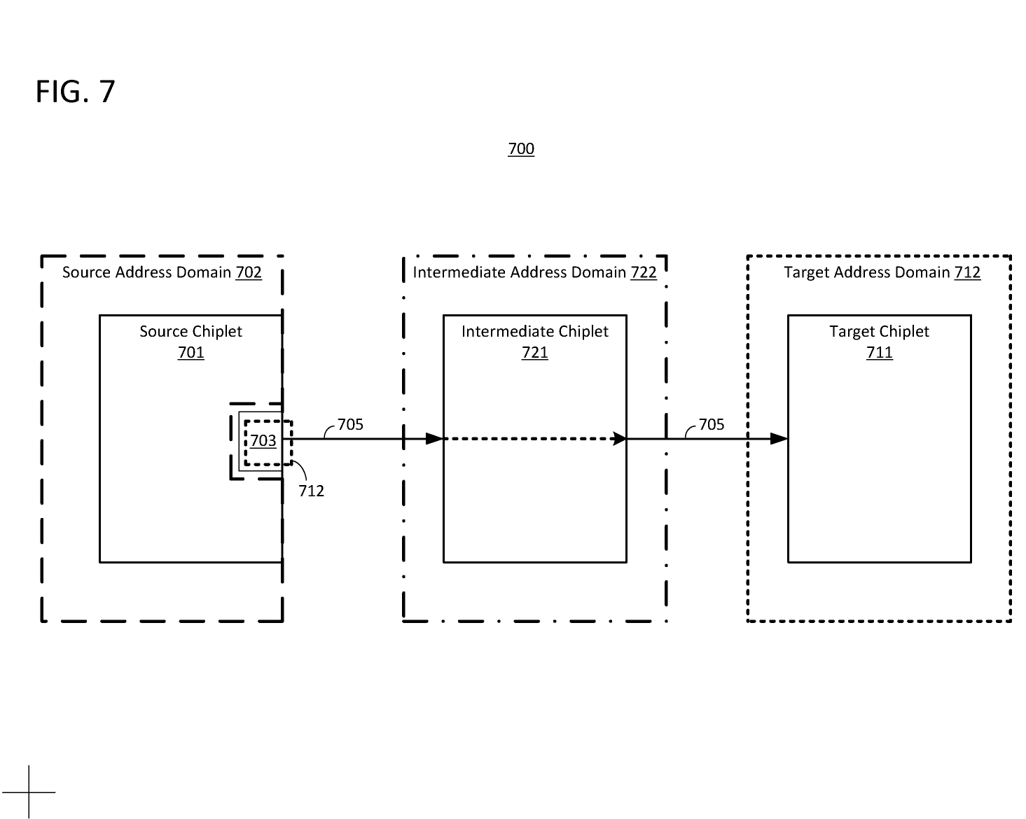

FIG. 7 illustrates an example of chiplet network 700 in accordance with specific embodiments of the inventions disclosed herein, in which a communication originating at a source chiplet traverses an intermediate chiplet before reaching a target chiplet, and in which translation between the source address map and the target address map occurs within the source chiplet. The arrangement shown in FIG. 7 differs from the arrangement shown in FIG. 6 in the location of the translator and, correspondingly, the address map in which the communication is expressed during its traversal of the intermediate chiplet.

In the illustrated embodiment, chiplet network 700 includes source chiplet 701, intermediate chiplet 721, and target chiplet 711. Source chiplet 701 is associated with source address domain 702, intermediate chiplet 721 is associated with intermediate address domain 722, and target chiplet 711 is associated with target address domain 712. As illustrated by the dashed boundaries depicting the address domains, target address domain 712 extends from target chiplet 711 into source chiplet 701, encompassing the portion of source chiplet 701 in which translator 703 is located. A separate portion of source chiplet 701 lies within source address domain 702.

Translator 703 is located within source chiplet 701 and is positioned at the entry point of target address domain 712. Although translator 703 is physically located within source chiplet 701, translator 703 is part of target address domain 712 rather than part of source address domain 702. Translator 703 is configured to translate addresses from the source address map of source address domain 702 into the target address map of target address domain 712.

In the illustrated embodiment, communication 705 originating within the portion of source chiplet 701 that lies within source address domain 702 carries an address expressed in the source address map. Upon reaching translator 703, communication 705 has its address translated into a translated address expressed in the target address map. Communication 705 then exits source chiplet 701 carrying the translated address, traverses intermediate chiplet 721, and arrives at target chiplet 711. The address carried by communication 705 remains expressed in the target address map throughout its traversal of intermediate chiplet 721 and the inter-chiplet communication paths between the chiplets.

In some embodiments, intermediate chiplet 721 is configured to forward the communication toward target chiplet 711 without modifying the address carried by the communication. Although intermediate chiplet 721 internally operates with respect to intermediate address domain 722 for its own internal traffic, the communication is not interpreted by intermediate chiplet 721 as a communication originating within intermediate address domain 722. Intermediate chiplet 721 may identify an outbound inter-chiplet port through which to forward the communication based on the address carried by the communication falling within an address region of the local address map of intermediate chiplet 721 allocated to that outbound inter-chiplet port. From the perspective of address translation, communication 705 remains within target address domain 712 throughout its traversal of intermediate chiplet 721, even though intermediate chiplet 721 itself is associated with intermediate address domain 722. In some embodiments, translation of the address carried by the communication is performed exactly once along the route between source chiplet 701 and a resource in target address domain 712 to which the communication is directed, at the entry point of target address domain 712 within source chiplet 701.

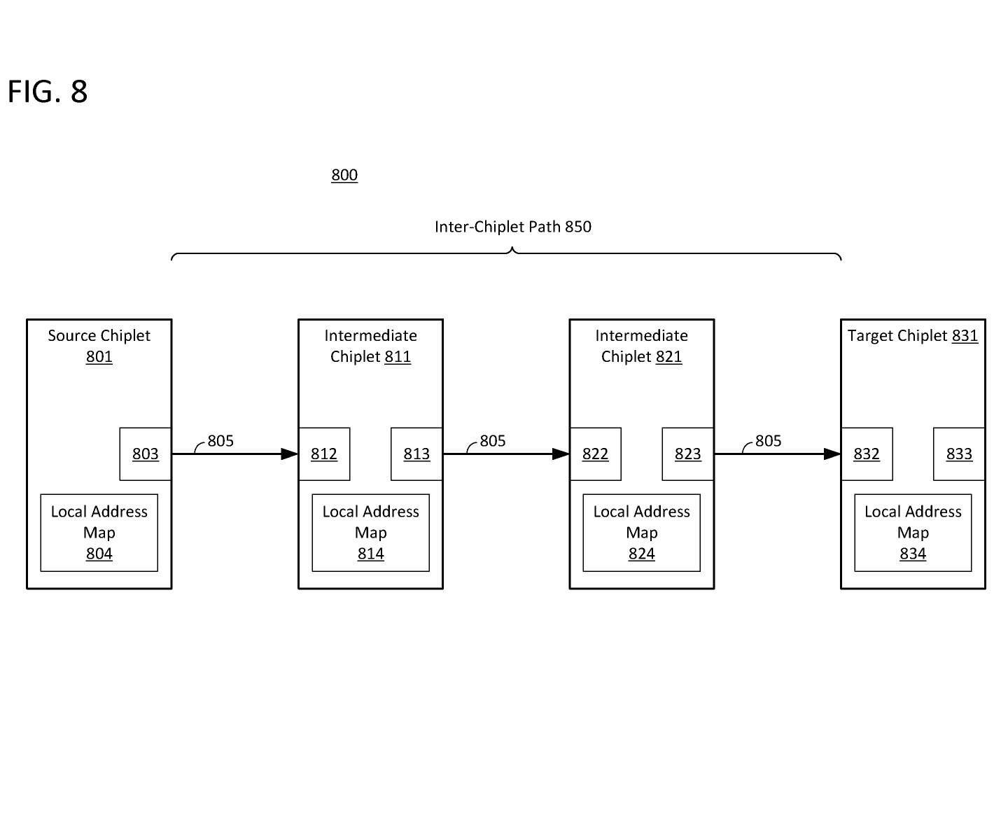

FIG. 8 illustrates an example of chiplet network 800 in accordance with specific embodiments of the inventions disclosed herein, in which a communication originating at a source chiplet traverses multiple intermediate chiplets along an inter-chiplet communication path before reaching a target chiplet. The arrangement shown in FIG. 8 illustrates how the disclosed framework may operate across paths of arbitrary length, with each intermediate chiplet along the path performing routing without modifying the address carried by the communication. This embodiment is non-limiting in that in alternative embodiments, each intermediate chiplet can serve as its own intermediate address domain as described herein.

In the illustrated embodiment, chiplet network 800 includes source chiplet 801, intermediate chiplet 811, intermediate chiplet 821, and target chiplet 831, coupled to one another in sequence by inter-chiplet path 850. Source chiplet 801 includes inter-chiplet port 803 and local address map 804. Intermediate chiplet 811 includes inter-chiplet port 812, inter-chiplet port 813, and local address map 814. Intermediate chiplet 821 includes inter-chiplet port 822, inter-chiplet port 823, and local address map 824. Target chiplet 831 includes inter-chiplet port 832, inter-chiplet port 833, and local address map 834. Inter-chiplet ports 812, 822, and 832 may be ingress ports or inbound ports. The arrangement of chiplets shown in FIG. 8 is illustrative; in other embodiments, more or fewer intermediate chiplets, different couplings, or different topology arrangements may be used.

In the illustrated embodiment, source chiplet 801 is configured to emit communication 805 directed to a resource in a target address domain associated with target chiplet 831. Communication 805 carries an address expressed in a source address map associated with source chiplet 801. Source chiplet 801 directs communication 805 to port 803 based on the address falling within an address region of local address map 804 allocated to port 803, and emits communication 805 through port 803 onto inter-chiplet path 850.

In some embodiments, each of intermediate chiplet 811 and intermediate chiplet 821 is configured to forward communication 805 toward target chiplet 831 without modifying the address carried by communication 805. Each intermediate chiplet receives communication 805 at its respective ingress port from an upstream chiplet along inter-chiplet path 850 and forwards communication 805 through its respective output port toward a downstream chiplet along inter-chiplet path 850. The address carried by communication 805 remains unchanged from when communication 805 is emitted from source chiplet 801 through port 803 until communication 805 reaches the target address domain associated with target chiplet 831.

In some embodiments, intermediate chiplet 811 receives communication 805 at inter-chiplet port 812 (e.g., an ingress port) from source chiplet 801. Intermediate chiplet 811 identifies inter-chiplet port 813 (e.g., an output port) as the appropriate outbound port through which to forward communication 805 based on the address carried by communication 805 falling within an address region of local address map 814 allocated to inter-chiplet port 813. Intermediate chiplet 811 forwards communication 805 through inter-chiplet port 813 with the address unchanged from the address carried by communication 805 when received at inter-chiplet port 812. Intermediate chiplet 811 does not perform translation of the address carried by communication 805.

In some embodiments, intermediate chiplet 821 receives communication 805 at inter-chiplet port 822 (e.g., an ingress or inbound port) from intermediate chiplet 811. Intermediate chiplet 821 identifies inter-chiplet port 823 as the appropriate outbound port through which to forward communication 805 based on the address carried by communication 805 falling within an address region of local address map 824 allocated to inter-chiplet port 823. Intermediate chiplet 821 forwards communication 805 through inter-chiplet port 823 with the address unchanged from the address carried by communication 805 when received at inter-chiplet port 822. Intermediate chiplet 821 does not perform translation of the address carried by communication 805.

In some embodiments, local address map 804 of source chiplet 801, local address map 814 of intermediate chiplet 811, local address map 824 of intermediate chiplet 821, and local address map 834 of target chiplet 831 are each defined independently of the others. Each local address map is used by the chiplet to which it belongs to make routing decisions for communications traversing that chiplet, without that chiplet needing to interpret the address carried by communication 805 in any other chiplet's address map. Intermediate chiplet 811 does not require knowledge of source chiplet 801's source address map, of target chiplet 831's target address map, or of any other chiplet's address map beyond local address map 814. Intermediate chiplet 821 does not require knowledge of any other chiplet's address map beyond local address map 824.

In some embodiments, communication 805 arrives at target chiplet 831 through inter-chiplet port 832, having traversed inter-chiplet path 850 and the two intermediate chiplets without modification of the address. Target chiplet 831 includes a translator (not separately depicted in FIG. 8) positioned at an entry point of the target address domain. The translator translates the address carried by communication 805 from the source address map into a target address map associated with the target address domain. In some embodiments, translation of the address carried by communication 805 is performed exactly once along the route between source chiplet 801 and a resource in the target address domain to which communication 805 is directed, at the entry point of the target address domain. In the illustrated embodiments, no translation of the address occurs at source chiplet 801, at intermediate chiplet 811, at intermediate chiplet 821, or at any other point along inter-chiplet path 850 outside of the target address domain. In alternative embodiments, each intermediate chiplet can serve as its own intermediate address domain as described herein.

In some embodiments, inter-chiplet port 833 of target chiplet 831 and local address map 834 of target chiplet 831 are usable by target chiplet 831 to forward communications originating within target chiplet 831 or arriving at target chiplet 831 to additional chiplets in chiplet network 800. Target chiplet 831 may thus also act as a source chiplet or as an intermediate chiplet with respect to other communications in chiplet network 800. The roles of source, intermediate, and target are per-communication and may vary across different communications traversing chiplet network 800.

In other embodiments of chiplet network 800, one or more of intermediate chiplet 811 and intermediate chiplet 821 is itself associated with an intermediate address domain through which communication 805 passes. In such embodiments, the intermediate chiplet receives communication 805 at an ingress inter-chiplet port, translates the address carried by communication 805 from the address map of an upstream address domain into the local address map of the intermediate address domain at an entry point of the intermediate address domain, forwards communication 805 based on the translated address through an outbound inter-chiplet port, and (upon the communication exiting the intermediate chiplet) leaves the address expressed in the intermediate chiplet's local address map until a subsequent translation occurs at an entry point of a downstream address domain. The address carried by communication 805 may accordingly undergo translation more than once along inter-chiplet path 850, with each translation occurring at the entry point of a respective address domain crossed by the communication. The illustrated embodiment of FIG. 8, in which the address remains unchanged through intermediate chiplets 811 and 821, and the alternative embodiment in which the address is translated at each intermediate chiplet's address-domain entry point, are both consistent with the disclosed framework's rule that translation occurs at the entry point of an address domain.

Accordingly, FIG. 8 should be understood as one non-limiting example of a chiplet arrangement in which a communication carrying an address traverses multiple intermediate chiplets along an inter-chiplet communication path, in which each intermediate chiplet uses its own local address map to make routing decisions, in which the address carried by the communication remains unchanged throughout traversal of the intermediate chiplets, and in which translation between the source address map and the target address map is performed exactly once along the route, at an entry point of the target address domain. The number and arrangement of intermediate chiplets, the structure of inter-chiplet paths, and the placement of address maps and ports may vary in different embodiments.

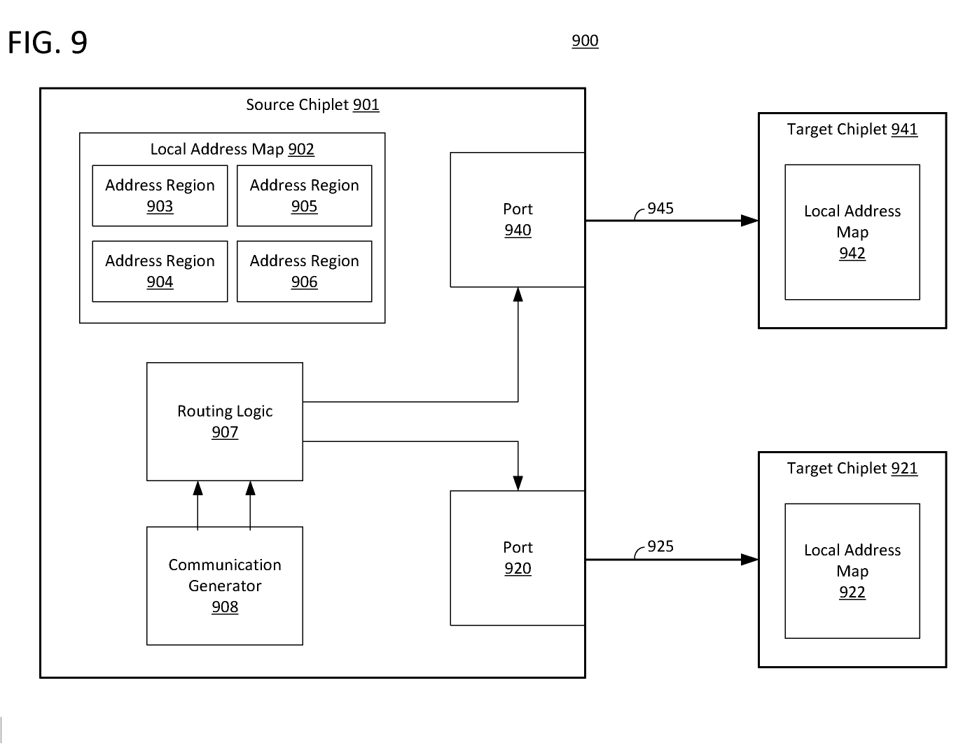

FIG. 9 illustrates an example of chiplet network 900 in accordance with specific embodiments of the inventions disclosed herein, in which a source chiplet uses its local address map to direct outgoing communications to different inter-chiplet ports based on the addresses carried by the communications. The arrangement shown in FIG. 9 illustrates how a single source chiplet may emit communications directed to different target chiplets through different inter-chiplet ports, with routing decisions made by reference to the source chiplet's own local address map rather than to any other chiplet's address map.

In the illustrated embodiment, chiplet network 900 includes source chiplet 901, target chiplet 921, and target chiplet 941. Source chiplet 901 is coupled to target chiplet 941 through port 940 and is coupled to target chiplet 921 through port 920. Source chiplet 901 has local address map 902. Target chiplet 921 has local address map 922. Target chiplet 941 has local address map 942. Each of local address map 902, local address map 922, and local address map 942 may be defined independently of the others.

In some embodiments, local address map 902 of source chiplet 901 defines address region 903 allocated to port 940, address region 904 allocated to port 920, address region 905 also allocated to port 940, and address region 906 allocated to local resources of source chiplet 901. Each address region may be distinct from each other address region. A chiplet can allocate a plurality of address regions to a single port. Each address region allocated to a given port may be contiguous within the local address map. In some embodiments, the quantity of address regions allocated to any single port of source chiplet 901 may be bounded by a predetermined maximum. For example, there may be four or fewer address regions allocated to a given port. In some embodiments, source chiplet 901 may allocate address regions to its inter-chiplet ports such that the total address space allocated to inter-chiplet ports is as large as practicable given the local resources of source chiplet 901, the bounded number of address regions per port, and the contiguity requirement for each region. Allocating a larger total address space to inter-chiplet ports may provide source chiplet 901 with a wider range of addresses through which to communicate with resources in target address domains reached through those ports, and may reduce constraints on how target address domains map their resources into the address regions made available by source chiplet 901. In some embodiments, the allocation of address regions to inter-chiplet ports is determined at design time of source chiplet 901 and remains fixed during operation.

In specific embodiments, source chiplet 901 includes routing logic 907 configured to receive outgoing communications from communication generator 908. Communication generator 908 may refer to any portion of chiplet 901 that generates a communication for a separate chiplet. For example, communication generator 908 may refer to a compute element executing instructions or operations that read from or write to memory located in other chiplets, a direct memory access engine, a controller, a coherence engine, or an interrupt generator. The outgoing communications may carry addresses expressed in local address map 902. Routing logic 907 may be configured to direct each outgoing communication to one of port 920 or port 940 (or other ports not shown) based on the address carried by the communication. When the address carried by an outgoing communication falls within an address region of local address map 902 allocated to port 920, the routing logic 907 may direct the communication to port 920, causing the address to be translated into the address domain of target chiplet 921. When the address carried by an outgoing communication falls within an address region of local address map 902 allocated to port 940, the routing logic may direct the communication to port 940, causing the address to be translated into the address domain of target chiplet 941. The routing logic may not modify the address carried by the communication.

In the illustrated embodiment, communication generator 908 generates communication 925 directed to a resource associated with target chiplet 921. Communication 925 carries an address expressed in local address map 902, the address falling within address region 904, which is allocated to port 920. Routing logic 907 may direct communication 925 to port 920 based on the address falling within address region 904; and source chiplet 901 may emit communication 925 through port 920 toward target chiplet 921. In specific embodiments, the address carried by communication 925 may remain expressed in local address map 902 of source chiplet 901 upon traversing port 920.

In the illustrated embodiment, communication generator 908 generates communication 945 directed to a resource associated with target chiplet 941. Communication 945 carries an address expressed in local address map 902, the address falling within address region 905, which is allocated to port 940. Routing logic 907 may direct communication 945 to port 940 based on the address falling within address region 905; and source chiplet 901 may emit communication 945 through port 940 toward target chiplet 941. In specific embodiments, the address carried by communication 945 may remain expressed in local address map 902 of source chiplet 901 upon traversing port 940.

In some embodiments, source chiplet 901 may make routing decisions for communication 925 and communication 945 without reference to local address map 922 of target chiplet 921 or to local address map 942 of target chiplet 941. Source chiplet 901 may not have awareness of address values used in target address domains associated with target chiplet 921 or target chiplet 941. The routing decision for each outgoing communication may be made entirely on the basis of source chiplet 901's local address map 902, which may define which address regions are allocated to which of source chiplet 901's inter-chiplet ports.

In some embodiments, source chiplet 901 may convey, through a configuration interface and during a boot process of chiplet network 900, address region allocation information specifying address regions of local address map 902 that are allocated to each of port 920 and port 940. The address region allocation information for port 920 may be conveyed to a configuration agent in a target address domain reachable through port 920, and the address region allocation information for port 940 may be conveyed to a configuration agent in a target address domain reachable through port 940. The receiving configuration agents may use the received address region allocation information to configure respective translators at the entry points of their respective target address domains, such that addresses arriving at each translator from source chiplet 901 can be correctly translated into the respective target address map.

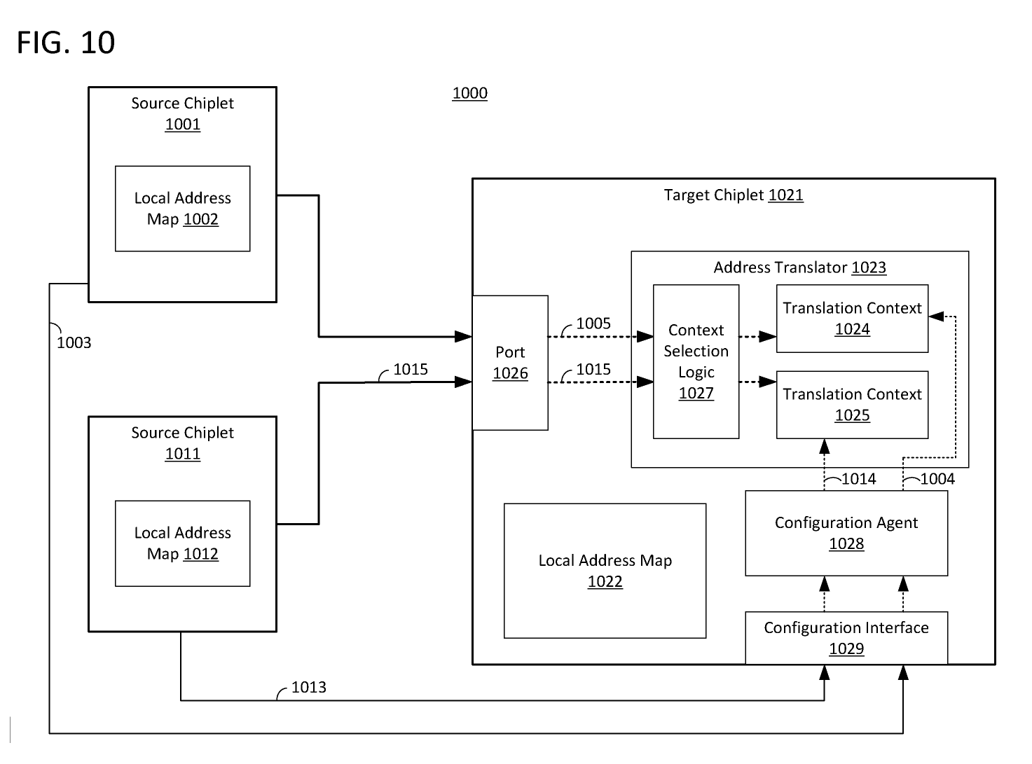

FIG. 10 illustrates an example of chiplet network 1000 in accordance with specific embodiments of the inventions disclosed herein, in which a target chiplet receives communications from multiple source chiplets through a shared ingress inter-chiplet port and maintains a plurality of translation contexts to translate addresses from each source chiplet's local address map into the target chiplet's local address map. The arrangement shown in FIG. 10 illustrates how communications from different source chiplets, potentially carrying overlapping address values that refer to different resources in their respective source chiplets, are translated correctly at the target chiplet using per-source translation contexts. FIG. 10 also illustrates how the translation contexts maintained by the target chiplet may be configured based on address region allocation information conveyed from the source chiplets to the target chiplet via boot channels during a boot process of chiplet network 1000.

In the illustrated embodiment, chiplet network 1000 includes source chiplet 1001, source chiplet 1011, and target chiplet 1021. Source chiplet 1001 operates under local address map 1002. Source chiplet 1011 operates under local address map 1012. Target chiplet 1021 operates under local address map 1022 and includes address translator 1023, context selection logic 1027, configuration agent 1028, port 1026, and configuration interface 1029. Source chiplet 1001 is coupled to configuration interface 1029 of target chiplet 1021 by boot channel 1003. Source chiplet 1011 is coupled to configuration interface 1029 of target chiplet 1021 by boot channel 1013. Address translator 1023 stores translation context 1024 for source chiplet 1001 and translation context 1025 for source chiplet 1011. Local address map 1002, local address map 1012, and local address map 1022 may each be defined independently of the others. The local address maps of source chiplet 1001 and source chiplet 1011 may permit overlapping address values that refer to different resources in their respective local address maps, and either or both may permit overlapping address values with local address map 1022 that refer to different resources.

In the illustrated embodiment, source chiplet 1001 emits communication 1005 directed to a resource associated with target chiplet 1021. Communication 1005 carries an address expressed in local address map 1002 of source chiplet 1001. Communication 1005 further carries a source identifier sufficient to permit target chiplet 1021 to associate communication 1005 with source chiplet 1001 as the source chiplet from which communication 1005 originated.

In the illustrated embodiment, source chiplet 1011 emits communication 1015 directed to a resource associated with target chiplet 1021. Communication 1015 carries an address expressed in local address map 1012 of source chiplet 1011. Communication 1015 further carries a source identifier sufficient to permit target chiplet 1021 to associate communication 1015 with source chiplet 1011 as the source chiplet from which communication 1015 originated.

In some embodiments, the source identifier carried with communication 1005 and the source identifier carried with communication 1015 may comprise one or more of: metadata carried with the communication, an identity of an ingress inter-chiplet port of the source chiplet from which the communication was emitted, a security identifier carried with the communication, an identity of an ingress inter-chiplet port of target chiplet 1021 at which the communication is received, or other source-distinguishing information conveyed alongside the communication. In specific embodiments, different chiplets may communicate with a target chiplet using different ports such that which ingress port was used is information sufficient to map the communication. In some embodiments, the source identifiers carried with communication 1005 and communication 1015 are distinct, allowing target chiplet 1021 to distinguish between communications originating from source chiplet 1001 and communications originating from source chiplet 1011 even when the communications arrive through the same ingress inter-chiplet port. In some embodiments, the security identifier carried with a communication comprises a static security identifier identifying a static security domain associated with the source of the communication, a dynamic security identifier identifying a dynamic security context associated with the source of the communication, or both. A static security identifier may be associated with a source chiplet at design time or at integration time of the multi-chiplet system, and may remain fixed during operation. A dynamic security identifier may be associated with a context that varies during operation of the multi-chiplet system, including by way of example a virtual machine, a process, a thread, or other software entity that may originate communications from a source chiplet. In some embodiments, target chiplet 1021 uses one or both of the static security identifier and the dynamic security identifier of a received communication to select a translation context for the communication, such that communications originating from the same source chiplet but associated with different security contexts may be translated using different translation contexts.

In the illustrated embodiment, communication 1005 and communication 1015 are both received at target chiplet 1021 through port 1026. Although the two communications may arrive at port 1026 from different source chiplets and may have been emitted at different times, port 1026 serves as a shared ingress inter-chiplet port through which target chiplet 1021 receives communications from multiple source chiplets in chiplet network 1000. In specific embodiments, a target chiplet may receive communications from different source chiplets through different ingress inter-chiplet ports.

In some embodiments, target chiplet 1021 includes address translator 1023 positioned at an entry point of a target address domain associated with target chiplet 1021. Address translator 1023 stores a plurality of translation contexts. Translation context 1024 corresponds to source chiplet 1001 and comprises information sufficient to translate addresses expressed in local address map 1002 of source chiplet 1001 into addresses expressed in local address map 1022 of target chiplet 1021. Translation context 1025 corresponds to source chiplet 1011 and comprises information sufficient to translate addresses expressed in local address map 1012 of source chiplet 1011 into addresses expressed in local address map 1022 of target chiplet 1021. Translation context 1024 and translation context 1025 are distinct from one another, even though both translate addresses into local address map 1022.

In some embodiments, target chiplet 1021 may include (e.g., within address translator 1023) context selection logic 1027 configured to select, for each received communication, one of the translation contexts stored by address translator 1023 based at least in part on the source identifier carried with the communication. When target chiplet 1021 receives communication 1005, context selection logic 1027 may use the source identifier carried with communication 1005 to identify source chiplet 1001 as the originating source chiplet and may select translation context 1024 accordingly. When target chiplet 1021 receives communication 1015, context selection logic 1027 may use the source identifier carried with communication 1015 to identify source chiplet 1011 as the originating source chiplet and may select translation context 1025 accordingly. The context selection logic may be implemented as part of address translator 1023, as a distinct hardware block coupled to the address translator, or in another suitable arrangement.

In some embodiments, address translator 1023 may translate the address carried by communication 1005 from local address map 1002 into local address map 1022 using translation context 1024, and may translate the address carried by communication 1015 from local address map 1012 into local address map 1022 using translation context 1025. Each translation may be performed using the translation context corresponding to the source chiplet from which the respective communication originated. In some embodiments, address translator 1023 may be configured to translate addresses carried by communications received from multiple source chiplets concurrently, each using the translation context corresponding to the originating source chiplet. In specific embodiments, communications from multiple source chiplets may be received via multiple ingress ports.

In some embodiments, the address carried by communication 1005 and the address carried by communication 1015 may have identical numerical values while still being translated correctly into local address map 1022. Because communication 1005 is translated using translation context 1024 and communication 1015 is translated using translation context 1025, two communications carrying identical address values but originating from different source chiplets may produce different translated addresses in local address map 1022. The two translated addresses may refer to different resources within target chiplet 1021 or accessible through target chiplet 1021, in accordance with the independent definitions of the source chiplets' local address maps.

In some embodiments, translation context 1024 and translation context 1025 are populated by configuration agent 1028 operating within the target address domain. Configuration agent 1028 may receive address region allocation information 1004 from source chiplet 1001 specifying address regions of local address map 1002 allocated to an inter-chiplet port of source chiplet 1001 through which target chiplet 1021 is reachable, and may use the received address region allocation information 1004 to populate translation context 1024. Similarly, configuration agent 1028 may receive address region allocation information 1014 from source chiplet 1011 specifying address regions of local address map 1012 allocated to an inter-chiplet port of source chiplet 1011 through which target chiplet 1021 is reachable, and may use the received address region allocation information 1014 to populate translation context 1025. In some embodiments, configuration agent 1028 may perform this population during a boot process of chiplet network 1000.

In the illustrated embodiment, address region allocation information 1004 is conveyed from source chiplet 1001 to target chiplet 1021 via boot channel 1003, and address region allocation information 1014 is conveyed from source chiplet 1011 to target chiplet 1021 via boot channel 1013. Boot channel 1003 and boot channel 1013 are received at target chiplet 1021 through configuration interface 1029. Configuration interface 1029 may serve as a boot channel ingress port through which target chiplet 1021 receives address region allocation information from one or more source chiplets in chiplet network 1000. In some embodiments, boot channel 1003 and boot channel 1013 are implemented over low-bandwidth, highly available interfaces distinct from the inter-chiplet communication path or paths on which communication 1005 and communication 1015 are conveyed. For example, boot channel 1003 and boot channel 1013 may be implemented by an I2C bus, an I3C bus, or another sideband management bus separate from the primary inter-chiplet communication path. In other embodiments, boot channel 1003 and boot channel 1013 are implemented over the same physical inter-chiplet communication path used to convey communication 1005 and communication 1015.

Source chiplet 1001 includes a configuration interface configured to convey address region allocation information 1004 to configuration agent 1028 of target chiplet 1021 via boot channel 1003. Source chiplet 1011 may include a configuration interface configured to convey address region allocation information 1014 to configuration agent 1028 of target chiplet 1021 via boot channel 1013. In some embodiments, the configuration interfaces of source chiplet 1001 and source chiplet 1011 convey address region allocation information 1004 and address region allocation information 1014, respectively, during a boot process of chiplet network 1000. The address region allocation information conveyed by each configuration interface may specify, for one or more inter-chiplet ports of the respective source chiplet through which target chiplet 1021 is reachable, one or more address regions of the respective source chiplet's local address map allocated to that inter-chiplet port. In some embodiments, the address region allocation information includes a base address of each allocated address region, and may further include a size of each allocated address region or an end address of each allocated address region.

Although FIG. 10 illustrates port 1026 and configuration interface 1029 as separate ingress ports of target chiplet 1021 — with communication 1005 and communication 1015 received through port 1026 and address region allocation information 1004 and address region allocation information 1014 received through configuration interface 1029 — in other embodiments, communications and address region allocation information may be received through the same ingress inter-chiplet port of target chiplet 1021. For example, an inter-chiplet communication path between source chiplet 1001 and target chiplet 1021 may carry both communication 1005 and address region allocation information 1004 to a shared ingress port of target chiplet 1021, and target chiplet 1021 may distinguish between communications carrying addresses to be translated and address region allocation information to be used for configuration based on protocol-level distinctions, channel identifiers, timing within the boot process, or other suitable means. Similarly, the configuration interface of a source chiplet and the routing logic used to emit communications carrying addresses may share a common inter-chiplet port of the source chiplet.

In some embodiments, configuration agent 1028 is configured to receive address region allocation information from each of one or more source chiplets through configuration interface 1029 (or through another port of target chiplet 1021), and to configure address translator 1023 — including translation context 1024, translation context 1025, and any additional translation contexts maintained by address translator 1023 — based on the received address region allocation information. In some embodiments, configuration agent 1028 performs this configuration during the boot process of chiplet network 1000, prior to communication 1005 and communication 1015 being emitted by their respective source chiplets. Once address translator 1023 has been configured by configuration agent 1028, address translator 1023 may operate autonomously to translate addresses carried by received communications without further involvement of configuration agent 1028 on a per-communication basis.

Accordingly, FIG. 10 should be understood as one non-limiting example of a chiplet arrangement in which a target chiplet receives communications from multiple source chiplets through a shared ingress inter-chiplet port, maintains a plurality of translation contexts each corresponding to one of the source chiplets, selects an appropriate translation context for each received communication based on a source identifier carried with the communication, and translates addresses carried by the communications from each source chiplet's local address map into the target chiplet's local address map using the selected translation context. FIG. 10 further illustrates how the translation contexts maintained by the target chiplet may be configured based on address region allocation information conveyed from each source chiplet to the target chiplet via boot channels during a boot process of the chiplet network. The number of source chiplets, the number of translation contexts maintained by the target chiplet, the form of the source identifier, the particular ports through which communications and address region allocation information are received, and the particular implementation of the address translator and context selection logic may vary in different embodiments.

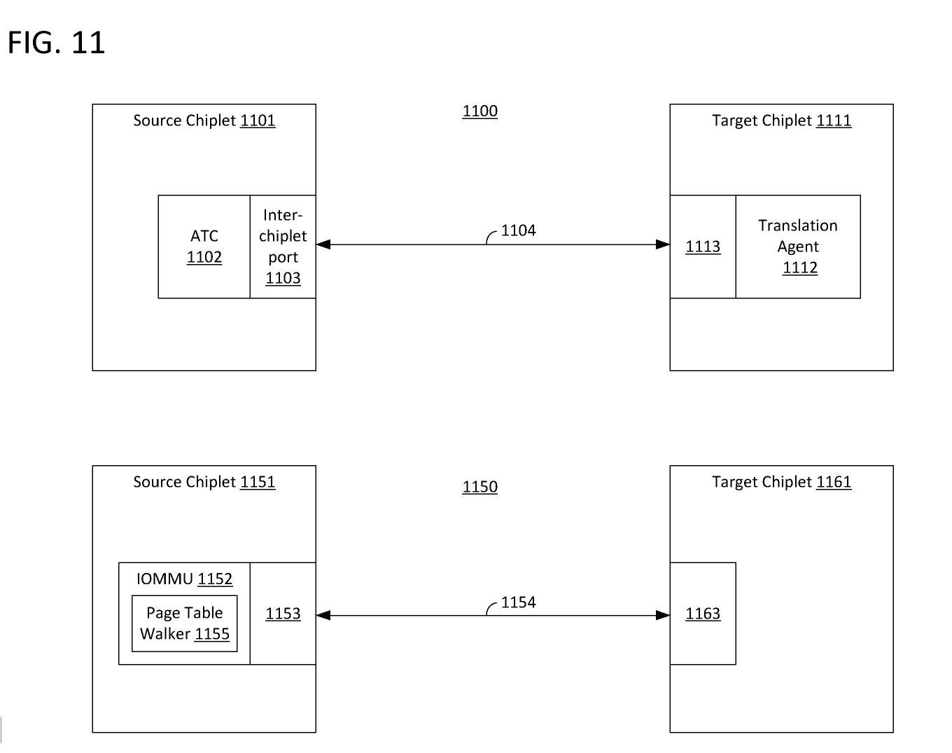

FIG. 11 illustrates two example chiplet network arrangements, chiplet network 1100 and chiplet network 1150, in accordance with specific embodiments of the inventions disclosed herein, in which a translator located within a source chiplet performs translation of addresses from a source address map into a target address map before communications carrying the translated addresses are emitted from the source chiplet. The two arrangements shown in FIG. 11 illustrate alternative embodiments of the translator: chiplet network 1100 illustrates a non-self-sufficient translator embodiment in which the translator cooperates with a remote translation agent located in the target chiplet to obtain translation information, and chiplet network 1150 illustrates a self-sufficient translator embodiment in which the translator performs translation independently without requiring assistance from translation logic located outside the source chiplet.

In the illustrated embodiment of chiplet network 1100, chiplet network 1100 includes source chiplet 1101 and target chiplet 1111 coupled to one another by inter-chiplet communication path 1104. Source chiplet 1101 includes address translation cache (ATC) 1102 and inter-chiplet port 1103. Target chiplet 1111 includes inter-chiplet port 1113 and an address translator that also functions as a translation agent. In the illustrated embodiment, the address translator and translation agent of target chiplet 1111 is implemented as translation agent 1112, which may comprise an IOMMU, though in other embodiments the address translator and translation agent of target chiplet 1111 may be implemented in other forms. Source chiplet 1101 is associated with a source address domain, and target chiplet 1111 is associated with a target address domain having a target address map.

In some embodiments, ATC 1102 is part of the target address domain such that the target address domain extends into source chiplet 1101 at ATC 1102. ATC 1102 may be configured to translate addresses from the source address map of source chiplet 1101 into the target address map of the target address domain using translation entries stored by ATC 1102. When source chiplet 1101 emits a communication directed to a resource in the target address domain, the address carried by the communication may be translated by ATC 1102 from the source address map into the target address map, and the communication is then emitted through inter-chiplet port 1103 onto inter-chiplet communication path 1104 carrying the translated address.

In some embodiments, ATC 1102 may store a limited number of translation entries, and may not have a valid translation entry for every address that a communication emitted by source chiplet 1101 might carry. When ATC 1102 lacks a valid translation for an address required by a communication, ATC 1102 may be configured to forward a translation request to translation agent 1112 located in target chiplet 1111 via inter-chiplet port 1103 and inter-chiplet communication path 1104. Translation agent 1112 may perform a translation lookup, retrieve a corresponding translation entry, and return the translation entry to ATC 1102 in a translation response via inter-chiplet communication path 1104 and inter-chiplet port 1103. ATC 1102 may then use the received translation entry to translate the address carried by the communication, and may store the received translation entry for use in translating subsequent communications carrying the same address.

In the illustrated embodiment, inter-chiplet communication path 1104 carries both translation requests and translation responses exchanged between ATC 1102 and translation agent 1112 and communications carrying translated addresses emitted by source chiplet 1101 toward target chiplet 1111. In some embodiments, the translation requests, the translation responses, and the communications carrying translated addresses are carried on logical channels that are distinct from one another, even though the logical channels share the same physical inter-chiplet communication path. In other embodiments, the translation requests and translation responses may be carried on a physical inter-chiplet communication path that is distinct from the physical inter-chiplet communication path on which the communications carrying translated addresses are conveyed.

In the illustrated embodiment of chiplet network 1150, chiplet network 1150 includes source chiplet 1151 and target chiplet 1161 coupled to one another by inter-chiplet communication path 1154. Source chiplet 1151 includes inter-chiplet port 1153 and an address translator in the form of IOMMU 1152 with page table walker 1155. Target chiplet 1161 includes inter-chiplet port 1163. Source chiplet 1151 is associated with a source address domain, and target chiplet 1161 is associated with a target address domain having a target address map.

In some embodiments, IOMMU 1152 is part of the target address domain such that the target address domain extends into source chiplet 1151 at IOMMU 1152. IOMMU 1152 may be configured to translate addresses from the source address map of source chiplet 1151 into the target address map of the target address domain. When source chiplet 1151 emits a communication directed to a resource in the target address domain, the address carried by the communication may be translated by IOMMU 1152 from the source address map into the target address map, and the communication may then be emitted through inter-chiplet port 1153 onto inter-chiplet communication path 1154 carrying the translated address.

In some embodiments, IOMMU 1152 may be configured to perform page-table-based translation of addresses from the source address map into the target address map. Page table walker 1155 of IOMMU 1152 may be configured to retrieve translation entries from memory accessible to IOMMU 1152. When IOMMU 1152 receives an address for which a corresponding translation entry is not currently cached within IOMMU 1152, page table walker 1155 may walk one or more levels of page tables in memory to locate the translation entry corresponding to the address, retrieve the translation entry, and provide the translation entry to IOMMU 1152 for use in translating the address.

In some embodiments, IOMMU 1152 may be self-sufficient with respect to translation. That is, IOMMU 1152 may be configured to perform translation lookups, walk page tables, retrieve translation entries, and produce translated addresses without requiring assistance from translation logic located outside source chiplet 1151. In contrast to the arrangement of chiplet network 1100, in which ATC 1102 forwards translation requests to translation agent 1112 in target chiplet 1111 when ATC 1102 lacks a valid translation, IOMMU 1152 in chiplet network 1150 may obtain translation entries through page table walker 1155 internally and may not need to forward translation requests across inter-chiplet communication path 1154 to obtain translations.

In the illustrated embodiment, inter-chiplet communication path 1154 carries communications carrying translated addresses emitted by source chiplet 1151 toward target chiplet 1161, but does not need to carry translation requests or translation responses between source chiplet 1151 and target chiplet 1161. In some embodiments, the absence of translation request and response traffic on inter-chiplet communication path 1154 reduces the bandwidth and latency overhead associated with translation, as compared to the non-self-sufficient embodiment shown in chiplet network 1100.

In some embodiments, the choice between a non-self-sufficient translator arrangement, as illustrated in chiplet network 1100, and a self-sufficient translator arrangement, as illustrated in chiplet network 1150, may be made based on factors including the available storage within the source chiplet for translation entries, the bandwidth and latency characteristics of the inter-chiplet communication path, the complexity of translation logic that the source chiplet is configured to implement, and other implementation-defined considerations. Both arrangements operate in accordance with the disclosed framework in which the entry point of the target address domain is located within the source chiplet and translation is performed at the entry point before the communication is emitted from the source chiplet.

Accordingly, FIG. 11 should be understood as illustrating two non-limiting examples of chiplet arrangements in which a translator located within a source chiplet performs translation at the entry point of a target address domain, with the translator implemented either as a non-self-sufficient address translation cache that cooperates with a remote translation agent in the target chiplet, or as a self-sufficient translation agent that performs translation independently using a page table walker. The particular form of the translator, the structure of the translation entries, the arrangement of the inter-chiplet communication path, and the manner of cooperation between the translator and any remote translation agent may vary in different embodiments.

In a specific embodiment of the disclosed framework, the multi-chiplet system is configured with concrete parameter values suitable for an automotive application or other application requiring deterministic operation and functional safety considerations. In one such embodiment, the address width of inter-chiplet communications is set to 64 bits, allowing inter-chiplet communications to carry addresses spanning an address space of up to 2^64 bytes. Source chiplets in the multi-chiplet system are configured to allocate up to four contiguous address regions to each of their inter-chiplet ports, with the base address and size of each allocated address region conveyed to target chiplets during a boot process of the multi-chiplet system. Target chiplets configure their respective address translators based on the received address region allocation information, such that addresses originating in source chiplets are translated into target address maps at the entry points of the target address domains in accordance with the configured translation contexts. In some such embodiments, the address translators at target chiplets enforce safety- and security-related constraints in addition to performing address translation, including isolation between traffic originating from different source chiplets and verification that translated addresses fall within ranges authorized for the originating source chiplet. The disclosed framework is not limited to this specific embodiment or to applications requiring deterministic operation; the disclosed framework is applicable to a wide variety of multi-chiplet systems and application contexts.

Embodiments of the disclosed frameworks may provide a variety of benefits over alternative approaches to handling addresses across the boundaries of independently-designed chiplets. By concentrating address translation at the entry point of the target address domain, embodiments of the disclosed framework may eliminate the need for global coordination of address maps across chiplets, allowing each chiplet to define its address map independently at design time and to be combined with chiplets from different designers or vendors without requiring address-space negotiation or design-time alignment. Because addresses carried by communications remain expressed in the source chiplet's address map throughout any portion of a route outside the target address domain, intermediate chiplets along the route may forward communications without any awareness of the address semantics of any other chiplet, allowing intermediate chiplets to be implemented simply, to be reused across diverse multi-chiplet systems, and to support arbitrary topology arrangements including extended, hub-based, distributed, and hierarchical topologies. By performing translation exactly once along the route, at a well-defined location, embodiments of the disclosed framework may avoid the inefficiency and potential inconsistency of multiple translations along a single path, may localize translation responsibility within the target address domain in a manner consistent with security and access-control boundaries of the assembled system, and may decouple proprietary translation mechanisms employed within a target chiplet from the standardized interface used for source-side declaration of address region allocations. The standardized boot-time declaration of address region allocations from source chiplets to configuration agents in target address domains may allow translation logic at target chiplets to be configured without runtime discovery or design-time coordination of address maps, supporting plug-and-play assembly of multi-chiplet systems from independently-designed chiplets. The support for per-source translation contexts at target chiplets may allow communications carrying identical address values but originating from different source chiplets to be translated correctly into different target-domain addresses, allowing source chiplets to use overlapping address values in their respective address maps without conflicts at any shared target chiplet. Embodiments of the disclosed framework may further accommodate a variety of translation mechanisms — including static remap units, dynamic page-table-based input/output memory management units, and address translation caches that cooperate with remote translation agents — within a common architectural rule, allowing chiplet designers to select translation mechanisms appropriate to their specific cost, performance, and complexity requirements without compromising interoperability with chiplets that have selected different mechanisms. Taken together, these properties may support assembly of multi-chiplet systems from independently-designed chiplets across a wide range of topologies, translation mechanisms, and use cases, while preserving the modularity and design independence that motivate the chiplet approach to integrated circuit design.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps for implementing or designing the systems described herein can be conducted by a processor operating with a computer-readable non-transitory medium storing instructions for those method steps. The computer-readable medium may be memory within a personal user device or a network accessible memory. Although examples in the disclosure were generally directed to address translation between two address domains, address translation between any number of address domains may be used. Similarly, although examples in the disclosure were generally directed to chiplet systems, other multi-die integrated circuit systems may be used. Embodiments described herein may also be directed to any suitable form of address translator, and are not limited to address translation caches, input/output memory management units, and static remap units. These and other modifications and variations to the present invention may be practiced by those skilled in the art, without departing from the scope of the present invention, which is more particularly set forth in the appended claims.

What is claimed is:

1. A source chiplet for use in a multi-chiplet system, the source chiplet comprising:
an inter-chiplet port for communicating with a target chiplet in the multi-chiplet system;
a local address map defining: (i) an address region that routes to local resources of the source chiplet, and (ii) an address region allocated to the inter-chiplet port;
routing logic configured to: (i) receive an outgoing communication carrying an address expressed in the local address map; and (ii) direct the communication to the inter-chiplet port based on the address falling within the address region allocated to the inter-chiplet port, without modifying the address expressed in the local address map; and
a configuration interface configured to convey a base address of the address region allocated to the inter-chiplet port to a configuration agent in a target address domain of the target chiplet;
wherein, at the inter-chiplet port, the address carried by the outgoing communication is expressed in the local address map of the source chiplet.

2. The source chiplet of claim 1, wherein the routing logic is configured to direct outgoing communications to the inter-chiplet port irrespective of an address map of the target chiplet, such that the source chiplet has no awareness of address values used in the target address domain.

3. The source chiplet of claim 1, wherein the configuration interface is configured to convey the base address during a boot process of the multi-chiplet system.

4. The source chiplet of claim 1, wherein the outgoing communication further carries a source identifier.

5. The source chiplet of claim 1, further comprising a second inter-chiplet port for communicating with a second target chiplet in the multi-chiplet system, wherein:
the local address map further defines an address region allocated to the second inter-chiplet port; and
the routing logic is further configured to: (i) receive a second outgoing communication carrying a second address expressed in the local address map; and (ii) direct the second communication to the second inter-chiplet port based on the second address falling within the address region allocated to the second inter-chiplet port, without modifying the second address.

6. The source chiplet of claim 1, wherein the configuration interface comprises a sideband interface separate from the inter-chiplet port, the sideband interface configured to convey the base address over a sideband communication channel distinct from a primary communication path of the inter-chiplet port.

7. The source chiplet of claim 6, wherein the sideband communication channel comprises one or more of an Inter-Integrated Circuit (I2C) channel, an Improved Inter-Integrated Circuit (I3C) channel, or another management bus.

8. A target chiplet for use in a multi-chiplet system, the target chiplet comprising:
one or more ingress inter-chiplet ports for receiving communications originating from one or more source chiplets in the multi-chiplet system, each communication carrying a source address expressed in a local address map of the source chiplet from which the communication originated;
a target address domain associated with the target chiplet, the target address domain having a target address map independent of the local address map of any source chiplet;
an address translator positioned at an entry point of the target address domain, the address translator configured to translate the source address of each received communication into a translated address expressed in the target address map;
a plurality of translation contexts, each translation context corresponding to a source from which communications originate, wherein each translation context comprises information sufficient to translate addresses expressed in that source's local address map into addresses expressed in the target address map;
context selection logic configured to select, for each received communication, one of the translation contexts of the plurality of translation contexts based at least in part on a source identifier associated with the received communication; and
a configuration interface configured to receive address region allocation information for each source chiplet whose communications the target chiplet is configured to receive;
wherein the address translator and the translation contexts are configured based on the address region allocation information received through the configuration interface.

9. The target chiplet of claim 8, wherein the target address map and a local address map of a source chiplet have address values that overlap but refer to different resources.

10. The target chiplet of claim 8, wherein the entry point of the target address domain is located at or downstream of the one or more ingress inter-chiplet ports.

11. The target chiplet of claim 8, further comprising a configuration agent within the target address domain, the configuration agent configured to receive the address region allocation information and to populate the translation contexts based on the received address region allocation information.

12. The target chiplet of claim 8, wherein the source identifier comprises one or more of: metadata carried with the communication, an identity of the ingress inter-chiplet port on which the communication was received, and a security identifier carried with the communication.

13. The target chiplet of claim 8, wherein the configuration interface is configured to receive the address region allocation information during a boot process of the multi-chiplet system.

14. The target chiplet of claim 8, wherein the address region allocation information specifies, for each inter-chiplet port of the source chiplet through which the target chiplet is reachable, one or more address regions of the source chiplet's local address map allocated to that inter-chiplet port.

15. The target chiplet of claim 8, wherein the source addresses received from each source chiplet are translated into the target address map according to the translation context corresponding to that source.

16. The target chiplet of claim 8, wherein the address translator comprises an input/output memory management unit (IOMMU) configured to perform page-table-based translation of source addresses into the target address map.

17. The target chiplet of claim 8, wherein the address translator comprises a static remap unit configured to translate source addresses into the target address map based on fixed mappings.

18. The target chiplet of claim 8, wherein the address region allocation information is determined at design time of the multi‑chiplet system and is available to the configuration interface from one or more of: a non‑volatile storage of the target chiplet, firmware embedded in the target chiplet, a firmware image associated with the multi‑chiplet system, and a non‑volatile storage of another chiplet participating in the target address domain.

19. The target chiplet of claim 8, wherein the address region allocation information is obtained by the configuration interface from a combination of (i) dynamic conveyance from one or more source chiplets during a boot process and (ii) static configuration data embedded in the target chiplet or accessible to the target chiplet from non-volatile storage.

20. The target chiplet of claim 8, wherein the configuration interface is configured to receive the address region allocation information over a sideband communication channel distinct from a primary communication path on which the received communications are conveyed.

21. The target chiplet of claim 8, wherein the address translator is configured to translate source addresses received from multiple source chiplets concurrently, each using the translation context corresponding to the originating source chiplet.

22. A network of chiplets comprising:
a first chiplet defining a first address domain having a first address map;
a second chiplet defining a second address domain having a second address map independent of the first address map, wherein the first address map and the second address map permit overlapping address values that refer to different resources in their respective address domains;
an inter-chiplet communication path coupling the first chiplet to the second chiplet; and
an address translator positioned at an entry point of the second address domain, the address translator configured to translate addresses from the first address map into the second address map;
wherein the first chiplet is configured to emit a communication directed to a resource in the second address domain, the communication carrying an address;
wherein, for any portion of a route that the communication traverses outside the second address domain, the communication carries the address expressed in the first address map; and
wherein, for any portion of the route that the communication traverses within the second address domain, the communication carries the address as translated by the address translator into the second address map.

23. The network of chiplets of claim 22, wherein the entry point of the second address domain is located within the second chiplet.

24. The network of chiplets of claim 22, wherein:
the entry point of the second address domain is located within the first chiplet;
the address translator is located within the first chiplet; and
the second address domain extends into the first chiplet.

25. The network of chiplets of claim 24, wherein the address translator located within the first chiplet comprises an address translation cache that stores translations from the first address map into the second address map.

26. The network of chiplets of claim 25, wherein the address translation cache is configured to, upon lacking a valid translation for an address, forward a translation request over the inter-chiplet communication path to a translation agent located in the second chiplet, and receive a translation response from the translation agent.

27. The network of chiplets of claim 22, wherein:
the inter-chiplet communication path traverses one or more intermediate chiplets, each intermediate chiplet associated with an intermediate address domain having an intermediate address map; and
at least one of the intermediate chiplets is configured to: (i) receive the communication at an entry point of the intermediate address domain associated with the intermediate chiplet; (ii) translate the address carried by the communication into the intermediate address map at the entry point; and (iii) forward the communication toward the second chiplet based on the translated address.

28. The network of chiplets of claim 22, wherein the address translator performs translation exactly once along the route, at the entry point of the second address domain.

29. The network of chiplets of claim 22, wherein:
the first chiplet defines the first address map independently of the second address map;
the second chiplet defines the second address map independently of the first address map; and
the first address map and the second address map are defined at design time of the respective chiplets.

30. The network of chiplets of claim 22, further comprising a third chiplet associated with a third address domain having a third address map independent of the first address map and the second address map, wherein communications between the third chiplet and the second chiplet are translated at the entry point of the second address domain using a translation context distinct from a translation context used for communications between the first chiplet and the second chiplet.

31. The network of chiplets of claim 22, wherein the address translator comprises a page-table-based dynamic address translator configured to translate addresses based on translation entries maintained in memory.

32. The network of chiplets of claim 22, wherein the address translator comprises a static remap unit configured to translate addresses based on fixed mappings between source address ranges and target address ranges.

33. The network of chiplets of claim 22, wherein the address translator is configured by a configuration agent operating within the second address domain.

34. The network of chiplets of claim 22, wherein the address translator is configured based on address region allocation information conveyed from the first chiplet to a configuration agent in the second address domain during a boot process of the network of chiplets.

35. The network of chiplets of claim 22, wherein the address translator is configured based on address region allocation information that is statically embedded in the second chiplet at design time of the network of chiplets.

36. The network of chiplets of claim 22, wherein an intermediate chiplet along a route of the communication from the first chiplet to a resource in the second address domain is configured to forward the communication toward the second chiplet based at least in part on routing information separate from the address carried by the communication, the routing information comprising one or more of: a target identifier, a source identifier, a destination chiplet identifier, channel metadata carried with the communication, and a security identifier carried with the communication.

37. A source chiplet for use in a multi-chiplet system, the source chiplet comprising:
a local address domain associated with the source chiplet, the local address domain having a local address map defined independently of address maps of other chiplets in the multi-chiplet system;
an inter-chiplet port for communicating with a target chiplet in the multi-chiplet system, the target chiplet being associated with a target address domain having a target address map independent of the local address map, the local address map and the target address map permitting overlapping address values that refer to different resources in their respective domains;
an address translator located within the source chiplet, the address translator being part of the target address domain such that the target address domain extends into the source chiplet at the address translator, the address translator configured to translate addresses from the local address map into the target address map;
routing logic configured to: (i) receive an outgoing communication carrying an address expressed in the local address map and directed to a resource in the target address domain; (ii) cause the address to be translated by the address translator into a translated address expressed in the target address map; and (iii) direct the communication to the inter-chiplet port based on the translated address; and
a configuration interface configured to receive, from a configuration agent operating within the target address domain, translation information enabling the address translator to translate addresses from the local address map into the target address map;
wherein the address carried by the outgoing communication, upon traversing the inter-chiplet port, is expressed in the target address map.

38. The source chiplet of claim 37, wherein the address translator comprises an address translation cache configured to, when lacking a valid translation for an address required by an outgoing communication, forward a translation request to a translation agent located in the target chiplet via the inter-chiplet port and to receive a corresponding translation response from the translation agent via the inter-chiplet port.

39. The source chiplet of claim 37, wherein the address translator comprises an input/output memory management unit (IOMMU) configured to perform page-table-based translation of addresses from the local address map into the target address map, the IOMMU including a page table walker configured to retrieve translation entries from memory without requiring assistance from translation logic located outside the source chiplet.

40. The source chiplet of claim 37, wherein the address translator comprises a static remap unit configured to translate addresses from the local address map into the target address map based on fixed mappings between source address ranges and target address ranges.
